(19) United States
(12) Patent Application Publication
(10) Pub. No.: US 2018/0332253 A1
(43) Pub. Date: Nov. 15, 2018

(54) INFORMATION RECORDING APPARATUS, INFORMATION RECORDING SYSTEM AND METHOD FOR CONTROLLING INFORMATION RECORDING APPARATUS

(71) Applicant: OLYMPUS CORPORATION, Tokyo (JP)

(72) Inventors: Manabu FUNADA, Tokyo (JP); Akira YUKITAKE, Tokyo (JP); Yoshiyuki FUKUYA, Sagamihara-shi (JP); Akira TANI, Sagamihara-shi (JP)

(73) Assignee: OLYMPUS CORPORATION, Tokyo (JP)

(21) Appl. No.: 15/971,046

(22) Filed: May 4, 2018

(30) Foreign Application Priority Data
May 10, 2017 (JP) 2017-093805

(51) Int. Cl. H04N 7/04; H04N 5/225; H04N 5/235; G06F 1/26

(52) U.S. Cl. CPC H04N 7/04; H04N 5/2256; G06F 1/26; H04N 5/2354; H04N 5/2351

(57) ABSTRACT

An information recording apparatus includes functions of a recording mode configured to acquire and record infonnation and a reproduction mode configured to make recorded information reproducible and is capable of acquiring operation information from an external device through communication and performing a coordinated operation based on the operation information, the information recording apparatus including a communication section configured to perform communication with the external device and a mode control section configured to select the reproduction mode as a mode executed when the information recording apparatus is started in the coordinated operation through the communication.

### CROSS REFERENCE TO RELATED APPLICATION

This application claims the benefit of Japanese Application No. 2017-093805 filed in Japan on May 10, 2017, the contents of which are incorporated herein by this reference.

### BACKGROUND OF THE INVENTION

### 1. Field of the Invention

The present invention relates to an information recording apparatus, an information recording system and a method for controlling the information recording apparatus.

### 2. Description of Related Art

A user uses an information acquiring apparatus or an information recording apparatus such as a camera, an IC recorder or an observation apparatus and an inspection apparatus to acquire, check, sense or record, if necessary, information such as an image, a movie or a voice. Among functions of such an apparatus or device, functions associated with acquisition of information are used as main functions. For this reason, such an apparatus or device is expected to acquire information without missing timing of acquiring information immediately after power is turned on. About various types of information recorded in the information recording apparatus, when, for example, the user wants to check photographed images or the user wants to show photographed images to other people, some information recording apparatuses are designed to be operated by the user to check such images. On the other hand, even when the user has no information recording apparatus at hand, the user may want to check various types of information recorded in the information recording apparatus.

Under such circumstances, techniques associated with information recording apparatuses whereby it is possible to check recorded information such as images using an information terminal such as a smartphone are in demand. For example, Japanese Patent Application Laid-Open Publication No. 2004-260286 discloses a technique associated with an image pickup apparatus configured to wirelessly transmit image data acquired through photographing to an image server.

### SUMMARY OF THE INVENTION

An information recording apparatus according to one aspect of the present invention is an information recording apparatus including functions of a recording mode configured to acquire and record information and a reproduction mode configured to make the recorded information reproducible and capable of acquiring operation information from an external device through communication and performing a coordinated operation based on the operation information, the information recording apparatus including a communication section configured to perform communication with the external device and a mode control section configured to select the reproduction mode as a mode executed when the information recording apparatus is started in the coordinated operation through the communication.

An information recording system according to another aspect of the present invention is provided with the information recording apparatus and the external device.

A method for controlling an information recording apparatus according to a further aspect of the present invention is a method for controlling an information recording apparatus including functions of a recording mode configured to acquire and record information and a reproduction mode configured to make recorded information reproducible and capable of acquiring operation information from an external device through communication and performing a coordinated operation operating based on the operation information, the method including performing communication with the external device and selecting the reproduction mode as a mode executed when the information recording apparatus is started in the coordinated operation through the communication.

Benefits of the invention will become more apparent from the following detailed description.

### BRIEF DESCRIPTION OF THE DRAWINGS

FIG. 1A is a block diagram illustrating a schematic configuration example of an information recording system according to a first embodiment;

FIG. 1B is a block diagram for describing a concept of a configuration when the information recording system according to the first embodiment is used;

FIG. 2 is a flowchart illustrating an example of an information recording apparatus control process according to the first embodiment;

FIG. 3 is a flowchart illustrating an example of an external device control process according to the first embodiment;

FIG. 4 is a flowchart illustrating an example of an information recording apparatus control process according to a modification of the first embodiment;

FIG. 5 is a block diagram illustrating a schematic configuration example of an information recording system according to a second embodiment;

FIG. 6 is a schematic diagram illustrating an example of a scene in which the information recording system according to the second embodiment is used;

FIG. 7 is a flowchart illustrating an example of a camera control process according to the second embodiment;

FIG. 8 is a flowchart illustrating an example of a state information acquiring process according to the second embodiment;

FIG. 9 is a flowchart illustrating an example of a restricted reproduction process according to the second embodiment;

FIG. 10 is a flowchart illustrating an example of a restricted photographing process according to the second embodiment;

FIG. 11A is a flowchart illustrating an example of a smartphone control process according to the second embodiment;

FIG. 11B is a flowchart illustrating an example of a smartphone control process according to the second embodiment;

FIG. 12A is a schematic diagram illustrating an example of function display of a smartphone according to the second embodiment;

FIG. 12B is a schematic diagram illustrating an example of thumbnail image display of a smartphone according to the second embodiment;

FIG. 12C is a schematic diagram illustrating an example of display during a reproduction process of a smartphone according to the second embodiment;

FIG. 12D is a schematic diagram illustrating an example of display during a photographing process of a smartphone according to the second embodiment; and

FIG. 13 is a flowchart illustrating an example of a state information acquiring process according to a modification of the second embodiment.

### DETAILED DESCRIPTION OF THE PREFERRED EMBODIMENTS

### First Embodiment

### <Configuration of Information Recording System>

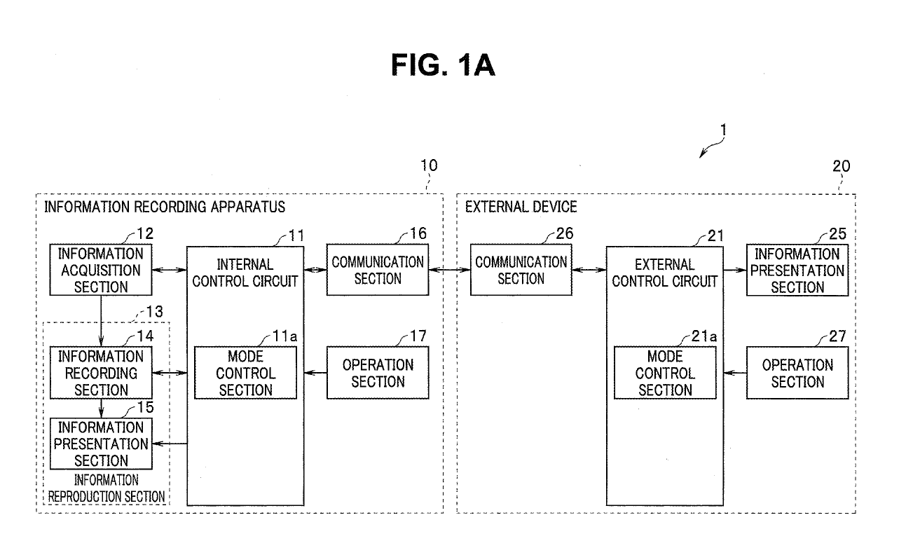

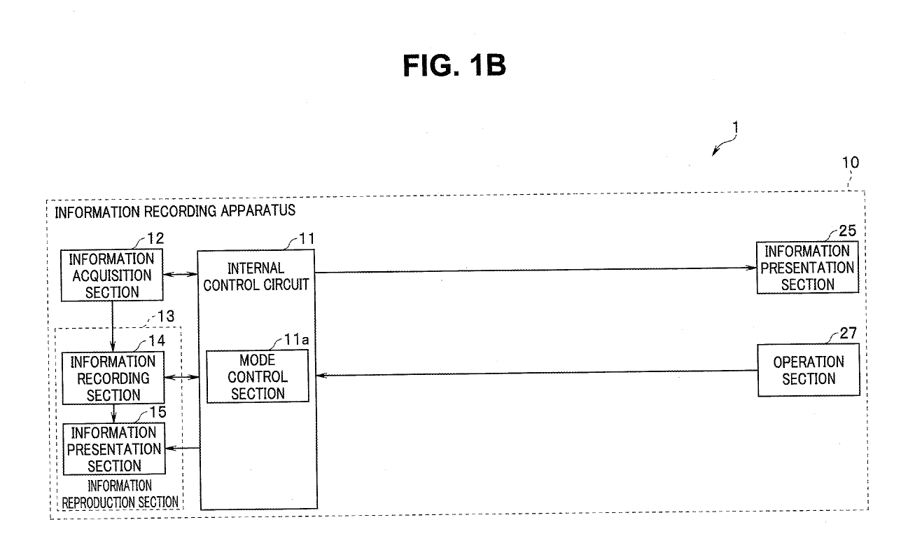

A first embodiment of the present invention will be described with reference to the accompanying drawings. A schematic configuration example of an information recording system 1 according to the present embodiment is shown in FIG. 1A as a block diagram and a configuration of the information recording system 1 will be described with reference to FIG. 1A.

As shown in FIG. 1A, the information recording system 1 according to the present embodiment includes an information recording apparatus 10 and an external device 20. The information recording apparatus 10 according to the present embodiment can execute functions of at least an information acquiring mode configured to acquire information and a reproduction mode configured to make recorded information reproducible. The information recording apparatus 10 according to the present embodiment may also be configured to be able to execute a function as a recording mode which is an information acquiring mode further including a function of recording the acquired information. Furthermore, the information recording apparatus 10 according to the present embodiment is also configured to be able to perform a coordinated operation operating based on a user operation acquired from the external device 20 through communication.

Hereinafter, in the present embodiment, the information recording system 1 will be described using a case where the information recording apparatus 10 is provided with the functions of the recording mode and the reproduction mode as an example. Here, the reproduction mode is a mode in which acquisition of information is prohibited, information acquired and recorded in advance by the information recording apparatus 10 or information recorded in the information recording apparatus 10 independently of the information acquired by the information recording apparatus 10 is made reproducible to be checked by the user.

In a situation in which acquisition of information is prohibited, complicated interests relating to personal information and copyrights or the like may be produced by, for example, possessing or using an apparatus that can acquire information. When information is acquired, power needs to be supplied to, for example, a sensor or a memory capacity may be consumed by recording or problems unexpected by the user may occur. Therefore, it is necessary to attach importance to distinction among an information acquiring mode in which information is acquired or a recording mode in which information can be acquired and recorded, and a reproduction mode in which acquisition of information is prohibited.

The information recording apparatus 10 may be any electronic device that can acquire and record various types of information, present the recorded information to the user and communicate the information with the external device 20. The information need not always be acquired by the device concerned. That is, the information to be presented to the user may be independent of the information acquired by the device, but may be information recorded in the device. Examples of the information recording apparatus 10 include a camera, an IC recorder, a tablet PC, a smartphone, a scanner, an electronic memo pad or a TV recorder. The information recording apparatus 10 having a high degree of portability in particular is required to reduce acquisition of unnecessary information due to constraints of a battery or memory. Therefore, it is necessary to manage operation of the information recording apparatus 10 at the startup so as to prevent the information recording apparatus 10 from unnecessary acquiring information in various places. The information recording apparatus 10 is provided with an internal control circuit 11, an information acquisition section 12, an information recording section 14, an information presentation section 15, a communication section 16 and an operation section 17.

The internal control circuit 11 controls operations of respective sections provided for the information recording apparatus 10. The internal control circuit 11 also acquires various types of information associated with operation of the information recording apparatus 10 and makes various types of determination associated with operation of the information recording apparatus 10. The internal control circuit 11 may also perform a process of converting the various types of information acquired by the information recording apparatus 10 to, for example, information for recording or information to be presented to the user. The internal control circuit 11 is provided with a function as a mode control section 11a. The mode control section 11 a is configured to determine and select, for example, which are of the reproduction mode and the recording mode is to be executed in the information recording apparatus 10. Note that the internal control circuit 11 may be further provided with a function as a notification control section configured to send notification or give a warning to the user.

The information acquisition section 12 acquires information from outside the information recording apparatus 10. When the information recording apparatus 10 is, for example, a camera, the information acquisition section 12 includes an image pickup section configured to pick up an image and generate image data and a microphone configured to acquire voice data. When the information recording apparatus 10 is, for example, an IC recorder, the information acquisition section 12 includes a microphone. Note that the information acquisition section 12 may include the operation section 17 to acquire a result of the user operation. When the information recording apparatus 10 is, for example, a tablet PC, the information acquisition section 12 may include an image pickup section, a microphone and a touch panel or the like to acquire the user operation.

In the information recording apparatus 10, for example, execution of a function such as presentation of acquired information to the user may be left to another device, which can also be expressed as a supplementary function (sub function). On the other hand, since speedy acquisition of information without missing timing constitutes a main function for the devices, functions associated with acquisition of information are started preferentially. Furthermore, the acquisition of information here may be acquisition of information executed by acquiring information and further acquiring other information from the result of analyzing the acquired information. The information recording apparatus 10 may be an inspection apparatus configured to acquire information and further acquire other information from the result of analyzing the acquired information and record the acquired information.

The information recording section 14 records programs and various parameters used in the respective sections provided for the information recording apparatus 10, and information obtained in the information acquisition section 12. Furthermore, the information recording section 14 temporarily records various types of information such as information acquired by the information acquisition section 12, information for recording, information to be presented to the user and processing information during operation. The information recording section 14 also records information associated with a connection destination during a coordinated operation of the external device 20 or the like.

The information presentation section 15 is configured to present information recorded in the information recording section 14 to the user. The information presentation section 15 includes a display to display, for example, image data and character string data, and a speaker to output voice data.

The information acquisition section 12 and the information recording section 14 execute a function of a recording mode in which information is acquired and recorded as an information input section. The information recording section 14 and the information presentation section 15 execute a function of a reproduction mode in which the recorded information is presented to the user as an information reproduction section 13. The function of the reproduction mode is a function of allowing information recorded by the information acquiring function that is a main function (function of the recording mode) to be reproduced (presented to the user) and not a function of executing reproduction (presented to the user) for checking live information such as an image during information recording of photographing and sound recording. The function of the reproduction mode is a function of executing reproduction (presented to the user) which can be expressed as a sub function when the information acquisition function is expressed as a main function and a function of causing the information presentation section such as a display section to present recording information such as images in the information recording apparatus 10 or the external device 20. The information presented here is not limited to images, but may be voice or information acquired by analyzing the acquired information. A feature of the function of the reproduction mode is that when the information recording apparatus 10 is an image pickup apparatus, an image photographed and recorded may be displayed as a thumbnail image on the display section of the information recording apparatus 10 or the external device 20 or displayed as an enlarged reproduced image.

The communication section 16 is configured to perform communication with the external device 20. For communication, radio communication using, for example, Wi-Fi (registered trademark), Bluetooth (registered trademark) is used. Furthermore, the information recording apparatus 10 and the external device 20 may be connected by a wire to perform communication with each other or may be connected to an electric communication channel such as the Internet to perform communication via the electric communication channel such as the Internet. The communication section 16 is configured to perform first communication mainly used to transmit/receive a control signal and second communication mainly used to transmit/receive various types of information such as image data.

The operation section 17 acquires the user operation. The operation section 17 may be an element that can acquire the user operation and examples of the operation section 17 include a touch panel, a push button, a knob, a slider, a dial, a lever or a keyboard.

On the other hand, the external device 20 may be an electronic device that can communicate with the information recording apparatus 10, control the information recording apparatus 10 through the communication, acquire information recorded in the information recording apparatus 10 through the communication and present the acquired information to the user. Examples of the external device 20 include a smartphone and a tablet PC. The external device 20 is provided with an external control circuit 21, an information presentation section 25, a communication section 26 and an operation section 27.

The external control circuit 21 controls operation of the respective sections provided for the external device 20. Furthermore, the external control circuit 21 acquires various types of information associated with operation of the external device 20 and makes various types of determination associated with operation of the external device 20. The external control circuit 21 is provided with a mode control section 21a. The mode control section 21a determines and selects which are of the reproduction mode and the recording mode is to be executed in the information recording apparatus 10. The mode control section 21a determines and selects the modes and various functions executed in the external device 20.

The information presentation section 25 presents information recorded in the external device 20 and information acquired from the information recording apparatus 10 or the like to the user. The information presentation section 25 includes, for example, a display to display, for example, image data, character string data and a speaker to output voice data.

The communication section 26 performs communication with the information recording apparatus 10. The communication may be directly performed and established with the information recording apparatus 10 or may be established via an electric communication channel such as the Internet. The communication section 26 performs first communication used to transmit/receive a control signal and second communication used to transmit/receive various types of information such as image data.

The operation section 27 acquires the user operation. The operation section 27 may be an element that can acquire the user operation, and examples of the operation section 27 include a touch panel, a push button, a knob, a slider, a dial, a lever or a keyboard.

Here, FIG. 1B illustrates a concept of a configuration of the information recording system 1 when the information recording system 1 according to the present embodiment is used. As shown in FIG. 1B, using the aforementioned information recording system 1, the user can check or view information recorded in the information recording apparatus 10 which the user does not have at hand despite the fact that the user is operating the operation section 27 provided for the external device 20 that the user has at hand. Similarly, the user can also cause the information recording apparatus 10 to perform operation associated with acquisition of information.

Note that the internal control circuit 11 and the external control circuit 21 include an integrated circuit such as a central processing unit (CPU), an application specific integrated circuit (ASIC) or a field programmable gate array (FPGA). The internal control circuit 11 and the mode control section 11a of the internal control circuit 11 may be composed of one integrated circuit or the like respectively or composed of a combination of a plurality of integrated circuits or the like respectively. Furthermore, the internal control circuit 11 and the mode control section 11a of the internal control circuit 11 may be composed of one integrated circuit or the like. Similarly, the external control circuit 21 and the mode control section 21a of the external control circuit 21 may be composed of one integrated circuit or the like respectively or composed of a combination of a plurality of integrated circuits or the like respectively. Furthermore, the external control circuit 21 and the mode control section 21a of the external control circuit 21 may be composed of one integrated circuit or the like. The integrated circuits are operated according to a program recorded in the information recording section 14, the external device 20 and a recording region in the integrated circuit or the like.

Note that the information recording section 14 or each element provided for the information recording section 14 is a non-volatile memory such as a flash memory, but may further include a volatile memory such as static random access memory (SRAM) or dynamic random access memory (DRAM). The information recording section 14 or each element provided for the information recording section 14 may be composed of one memory or the like respectively or composed of a combination of a plurality of memories or the like. A data server or the like located outside the information recording system 1 may be used as part of the memory.

<Operation of Information Recording System>

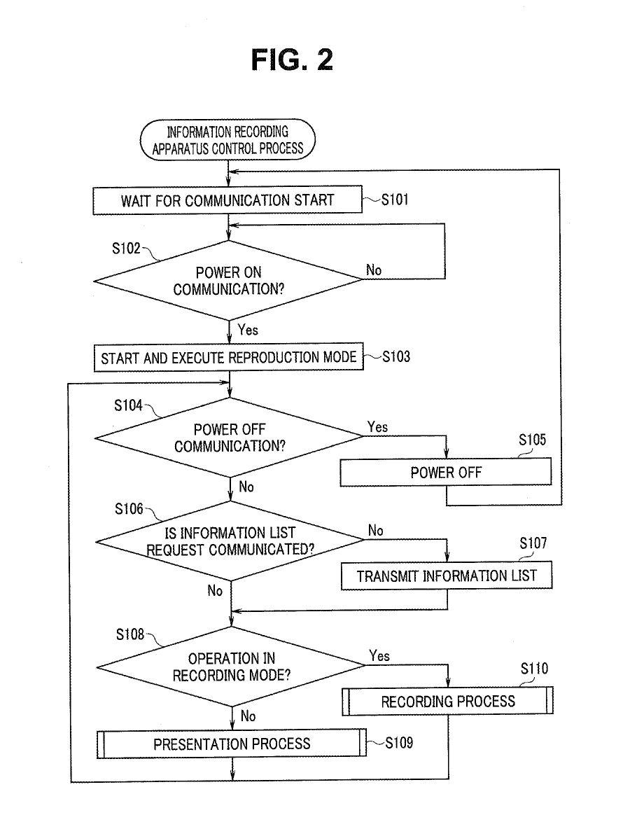

An example of an information recording apparatus control process carried out in the information recording apparatus 10 is shown in FIG. 2 as a flowchart and operation of the information recording system 1 will be described with reference to the flowchart. Note that a case will be described here as an example where the information recording apparatus 10 is controlled by the external device 20 through communication and a coordinated operation is started.

In step S101, the internal control circuit 11 waits until communication with the external device 20 is established. At this time, assume that the information recording apparatus 10 is in a power-off state and the communication section 16 is supplied with power and has been started. After the communication is established, the information recording apparatus control process proceeds to step S102. In step S102, the internal control circuit 11 determines whether or not power ON communication for instructing turning on of power to the information recording apparatus 10 is received. The information recording apparatus control process repeats the process until it is determined that power ON communication is received, and when such a determination is made, the process proceeds to step S103.

In step S103, the internal control circuit 11 starts to supply power to the respective sections provided for the information recording apparatus 10 following the power ON communication and turns on power to the information recording apparatus 10. At this time, the mode control section 11a determines that a connection is made from the external device 20 through communication and a coordinated operation is started in which the function of the information recording apparatus 10 is used, and selects the reproduction mode which is the mode in which acquisition of information is prohibited as the mode executed by the information recording apparatus 10. That is, when communication with the external device 20 is carried out and a coordinated operation is performed, the information recording apparatus 10 according to the present embodiment starts in the reproduction mode and starts a coordinated operation. The coordinated operation is not always limited to a case where the reproduction mode is executed. For example, it is also important that the information acquiring mode or the recording mode be executed by the coordinated operation. Furthermore, when power is turned on through communication, the information recording apparatus 10 can execute the information acquiring mode or the recording mode, but this is not a desirable design for the following reasons. That is, regarding the device for which acquisition of information is a main function, when acquisition of information is started indiscriminately, for example, by a remote operation, an unexpected trouble may occur. For example, photographing or sound recording may be conducted in a situation in which photographing or sound recording is prohibited or an owner of the device may record a work, the copyright of which is not held by the owner.

In step S104, the internal control circuit 11 determines whether or not power OFF communication for instructing turning off of power to the information recording apparatus 10 is received. The information recording apparatus control process proceeds to step S105 when it is determined that power OFF communication is received or proceeds to step S106 when such a determination is not made. In step S105, the internal control circuit 11 turns off power to the information recording apparatus 10. At this time, a power supply to the communication section 16 that performs first communication is continued and the information recording apparatus 10 is brought into a communication standby state. After that, the information recording apparatus control process returns to step S101.

In step S106, the internal control circuit 11 determines whether or not information list request communication for requesting an information list is received from the external device 20. The information list request communication is performed through first communication. The information list is a list recorded in the information recording section 14 provided for the information recording apparatus 10 and indicating various types of information that can be presented to the user. For example, an information list associated with image data and movie data may include thumbnail images showing respective pieces of data. The information recording apparatus control process proceeds to step S107 when it is determined that the information list request communication is received or proceeds to step S108 when such a determination is not made. In step S107, the internal control circuit 11 reads the information list from the information recording section 14. The internal control circuit 11 causes the communication section 16 to perform second communication for transmitting the information list to the external device 20. After that, the information recording apparatus control process proceeds to step S108.

In step S108, the internal control circuit 11 determines whether or not first communication for instructing transition to the recording mode is received from the external device 20. The information recording apparatus control process proceeds to step S110 when it is determined that an operation for instructing transition to the recording mode is performed or proceeds to step S109 when such a determination is not made.

In step S109, the internal control circuit 11 executes a process associated with presentation of information (presentation process). The presentation process is a process in the reproduction mode in which recording information recorded in the information recording section 14 is presented to the user. In the presentation process, upon receiving a presentation instruction for instructing transmission of recording information to be presented to the user from the external device 20, the internal control circuit 11 causes the communication section 16 to transmit the recording information to the external device 20 in accordance with the presentation instruction. In the presentation process, the internal control circuit 11 determines whether or not to end the presentation process. The determination is made based on a control signal received from the external device 20, a reproduction time period of the recording information and an elapsed time period after the start of presentation. When it is determined that the presentation process is ended, the process is ended and the process returns to step S104 of the information recording apparatus control process.

In step S110, the internal control circuit 11 switches the mode to be executed from the reproduction mode to the recording mode and executes a process associated with recording of information (recording process). The recording process is a process in the recording mode in which information acquired by the information acquisition section 12 is recorded in the information recording section 14 as recording information. In the recording process, the internal control circuit 11 causes the information acquisition section 12 to start to acquire information and causes the communication section 16 to transmit the live information acquired by the information acquisition section 12 to a set transmission destination. The live information includes, for example, a live view image. Note that a case will be described in the present embodiment as an example where the transmission destination is set in advance and recorded in the information recording section 14 or the like, but the present invention is not limited to the example. The transmission destination may also be set in, for example, the recording process. Furthermore, upon receiving adjustment communication including an adjustment instruction from the external device 20, the internal control circuit 11 performs adjustment and setting of various parameters associated with the recording process according to the adjustment instruction. When, for example, the information recording apparatus 10 is a camera, the adjustment instruction includes a control signal for adjusting focusing. Furthermore, for example, when information to be acquired is a movie, the adjustment communication includes a control signal for setting a movie compression method or the like. Furthermore, upon receiving recording control communication including a recording instruction from the external device 20, the internal control circuit 11 causes the information acquisition section 12 to acquire information with a recording setting according to the recording instruction and record the information in the information recording section 14. Here, the recording instruction includes control signals to control operation associated with a recording process of the information recording apparatus 10 such as recording start, recording stop or recording end. In the recording process, the internal control circuit 11 determines whether or not to end the recording process. Such a determination is made based on a control signal received from the external device 20 and a control signal or the like outputted from the operation section 17 provided for the information recording apparatus 10 in accordance with the user operation. When it is determined that the recording process is ended, the internal control circuit 11 ends the process and returns to step S104 of the information recording apparatus control process.

Note that in step S108, the user may instruct transition to the recording mode by operating the operation section 17 provided for the information recording apparatus 10. In this case, a presentation instruction in the presentation process, and an adjustment instruction and a recording instruction in the recording process may be performed based on the output of the operation section 17. The recording information and the live information may be transmitted to the external device 20 based on the output of the operation section 17 and presented to the user by the external device 20 or may be presented to the user by the information presentation section 15 provided for the information recording apparatus 10.

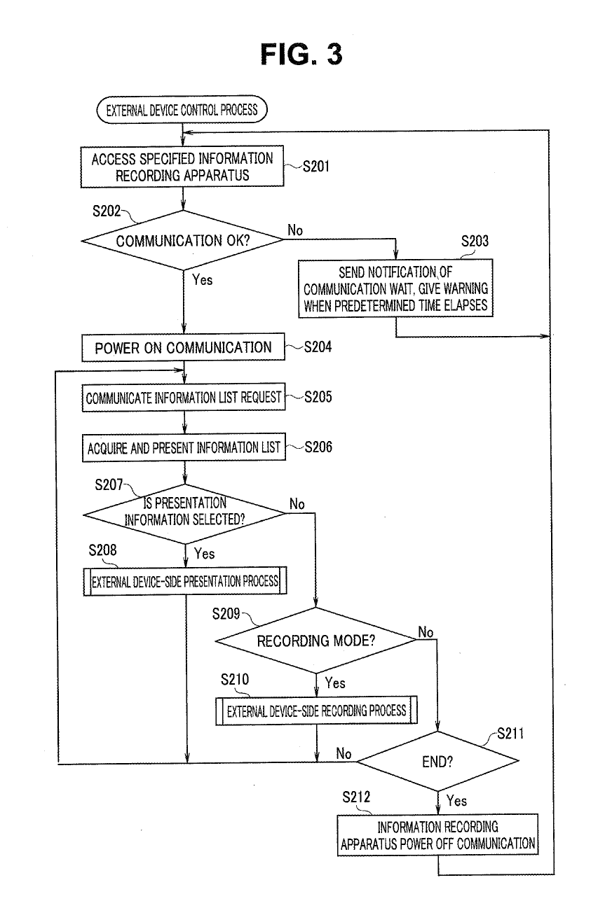

Here, an example of the external device control process performed by the external device 20 is shown in FIG. 3 as a flowchart and operation of the information recording system 1 will be described with reference to the flowchart. Here, an operation after the user selects the function associated with the coordinated operation with the information recording apparatus 10 by operating the external device 20 will be described. Here, assume that infonnation associated with the information recording apparatus 10 is set in advance as the connection destination of the external device 20 in the coordinated operation and recorded in the external device 20. The information associated with the information recording apparatus 10 is set, for example, in accordance with the user operation in the external device 20.

In step S201, the external control circuit 21 causes the communication section 26 to start communication with the information recording apparatus 10. In step S202, the external control circuit 21 determines whether or not communication is established. The external device control process proceeds to step S204 when it is determined that communication is established or proceeds to step S203 when such a determination is not made. In step S203, the external control circuit 21 sends notification to the user that the apparatus is waiting for communication during a trial for establishing communication. Furthermore, when a predetermined time period elapses after the trial for establishing communication is started, the external control circuit 21 gives a warning to the user that communication cannot be established. After that, the external device control process returns to step S201. Note that the process in the present step corresponds to the process in step S101 of the information recording apparatus control process.

In step S204, the external control circuit 21 causes the communication section 26 to perform power ON communication for instructing turning on of power to the information recording apparatus 10. Note that the process in the present step corresponds to the process in step S102 of the information recording apparatus control process.

In step S205, the external control circuit 21 causes the communication section 26 to perform information list request communication. In step S206, the external control circuit 21 acquires the information list from the information recording apparatus 10 through communication and presents the acquired information to the user. When, for example, the external device 20 is provided with a display, the information list is displayed on the display. Note that the processes in step S205 and step S206 correspond to the processes in step S106 and step S107 of the information recording apparatus control process.

In step S207, the external control circuit 21 determines whether or not the recording information to be presented to the user (presentation information) is selected from the recording information shown in the information list based on, for example, the output of the operation section 27 in accordance with the user operation. The external device control process proceeds to step S208 when it is determined that the presentation information is selected or proceeds to step S209 when such a determination is not made.

In step S208, the external control circuit 21 executes an external device-side presentation process. The external device-side presentation process is a process in which the presentation information acquired from the information recording apparatus 10 is presented to the user in the external device 20. The external control circuit 21 causes the communication section 26 to transmit a presentation instruction for transmitting the selected presentation information to the information recording apparatus 10. Furthermore, the external control circuit 21 acquires the presentation information from the information recording apparatus 10 and causes the information presentation section 25 to present the presentation information to the user. Furthermore, the external control circuit 21 determines whether or not to end the external device-side presentation process and return to the presentation of the information list. In such a determination, it is determined that the process is ended, for example, when the presentation of the presentation information ends, when a predetermined time period elapses after the presentation of the presentation information starts, when the operation section 27 detects the user operation for ending the presentation of the information or the like. Here, the case where the presentation of the presentation information ends means, when the presentation information is, for example, a movie, a case where the movie reproduction time period ends. The external device control process returns to step S205 when it is determined that the external device-side presentation process is ended. Note that the process in the present step corresponds to the process in step S109 of the information recording apparatus control process.

In step S209, the external control circuit 21 determines whether or not to cause the information recording apparatus 10 to transition to the recording mode based on, for example, the output of the operation section 27 according to the user operation. The external device control process proceeds to step S210 when the transition is determined or proceeds to step S211 when such a determination is not made.

In step S210, the external control circuit 21 executes an external device-side recording process. The external device-side recording process is a process for causing the information recording apparatus 10 to perform a recording process through a coordinated operation. The external control circuit 21 causes the communication section 26 to transmit a control signal for instructing transition to the recording mode to the information recording apparatus 10. Furthermore, the external control circuit 21 acquires live information from the information recording apparatus 10 through second communication and causes the information presentation section 25 to present the live information to the user. Furthermore, the external control circuit 21 causes the communication section 26 to execute adjustment communication including an adjustment instruction and recording control communication including a recording instruction according to the output of the operation section 27 in accordance with, for example, the user operation. The external control circuit 21 further determines whether or not to end the external device-side recording process based on the output of the operation section 27 according to, for example, the user operation. When it is determined to end the external device-side recording process, the external control circuit 21 causes the communication section 26 to transmit a control signal for ending the operation of the information recording apparatus 10 associated with the recording process to the information recording apparatus 10. The external device control process ends the process when it is determined to end the process and returns to step S205. Note that the process in the present step corresponds to the process in step S110 of the information recording apparatus control process.

In step S211, the external control circuit 21 determines whether or not to end the coordinated operation with the information recording apparatus 10 based on the output of the operation section 27 in accordance with, for example, the user operation. The external device control process proceeds to step S212 when it is determined that the coordinated operation is ended or returns to step S205 when such a determination is not made. In step S212, the external control circuit 21 causes the communication section 26 to perform power OFF communication for instructing turning off of power to the information recording apparatus 10. After that, the external device control process returns to step S201. Note that the process in the present step corresponds to the processes in step S104 and step S105 of the information recording apparatus control process.

Note that a case has been described as the aforementioned information recording apparatus control process as an example where power to the information recording apparatus 10 is turned on through communication from the external device 20 and a coordinated operation is started, but the operation of the information recording apparatus 10 is not limited to the operation. The information recording apparatus 10 may be started in accordance with, for example, the user operation acquired by the operation section 17. The information recording apparatus 10 is started in the recording mode when the power is turned on based on the output of the operation section 17.

After being started in the recording mode, the information recording apparatus 10 starts a non-coordinated operation in which the information recording apparatus 10 operates singly without communicating with nor in coordination with the external device 20. At this time, the information recording apparatus 10 adopts the recording mode or the reproduction mode as the mode to be executed during a non-coordinated operation based on, for example, the output of the operation section 17.

After being started in the recording mode, if communication with the external device 20 is established, the information recording apparatus 10, for example, communicates with the external device 20 and starts a coordinated operation. At this time, the information recording apparatus 10 adopts the recording mode or the reproduction mode as the mode to be executed during a coordinated operation based on a control signal in accordance with, for example, the user operation received from the external device 20.

### <Advantage of Information Recording System>

The information recording apparatus 10 according to the present embodiment has functions of the recording mode in which information is acquired and recorded and the reproduction mode in which recorded information is reproduced, and can acquire information (operation information) associated with the user operation from the external device 20 through communication and perform a coordinated operation in which the information recording apparatus 10 operates based on the operation information. The coordinated operation is started, when the power of the information recording apparatus 10 is off and a power ON signal is received from the external device 20 after communication with the external device 20 is established. Furthermore, the information recording apparatus 10 according to the present embodiment selects the reproduction mode as the mode to be executed at the start of the coordinated operation. Therefore, when the user checks various types of information recorded in the information recording apparatus through communication, for example, in a case where the user has no information recording apparatus 10 at hand, the information recording apparatus 10 according to the present embodiment starts in the reproduction mode and executes the coordinated operation. That is, the information recording apparatus 10 according to the present embodiment executes the reproduction mode when the information recording apparatus 10 starts in coordinated operation through communication.

The power of the information recording apparatus 10 according to the present embodiment may also be turned on based on the output of the operation section 17 provided for the information recording apparatus 10 in accordance with, for example, the user operation. In this case, the information recording apparatus. 10 according to the present embodiment starts in the recording mode. After the information recording apparatus 10 starts in the recording mode, the recording mode or the reproduction mode is selected in accordance with the output of the operation section 17, a non-coordinated operation is started or the recording mode or the reproduction mode is selected in accordance with a control signal received when communication with the external device 20 is started and the coordinated operation is started.

Thus, the information recording apparatus 10 according to the present embodiment can select and execute an appropriate mode in accordance with the situation. For example, in a situation in which the user is operating the information recording apparatus 10 at hand, a demand for the recording mode exists, for example, the user can adjust or arrange the information recording apparatus 10 while operating the information recording apparatus 10 for recording, and so the information recording apparatus 10 according to the present embodiment starts in the recording mode. Therefore, even when the moment comes suddenly when the user wants to record the scene, it is possible to record the scene using the information recording apparatus 10 according to the present embodiment without missing the timing. When the user wants to use the reproduction mode, the user may operate the operation section 17 after starting in the recording mode and cause the mode to transition to the reproduction mode.

For example, when power is turned on through communication and a coordinated operation is performed, a demand for the reproduction mode such that the user wants to remotely check information exists, and therefore the information recording apparatus 10 according to the present embodiment executes the reproduction mode. Therefore, the user can simply check the recording information recorded in the information recording apparatus 10 through communication by only operating the external device 20.

For example, after the information recording apparatus 10 is started in the recording mode, if communication with the external device 20 is established and a coordinated operation is started, the information recording apparatus 10 adopts the recording mode or the reproduction mode as the mode to be executed during the coordinated operation. The mode is selected based on, for example, a control signal in accordance with the user operation received from the external device 20. Therefore, the user can remotely use the function of the recording mode after adjusting or arranging the information recording apparatus 10 for recording when the information recording apparatus 10 is in a power-on state. Furthermore, the user can remotely use the function of the reproduction mode after setting or arranging the information recording apparatus 10 for reproduction by connecting the information recording apparatus 10 to an external reproduction device provided with an information presentation function when the information recording apparatus 10 is in a power-on state.

Note that although a case has been described in the present embodiment as an example where the information recording apparatus 10 is provided with the functions of the recording mode in which it is possible to acquire and record information and the reproduction mode that is a mode in which information acquisition is prohibited and in which it is possible to reproduce the recorded information, the present invention is not limited to the case. In the aforementioned embodiment, even when the recording mode is replaced by an information acquiring mode which is a mode in which information is acquired without being recorded, effects similar to the effects of the aforementioned information recording apparatus 10 can be obtained. In this case, the acquired information may be recorded outside the information recording apparatus 10.

Note that although a case has been described in the present embodiment as an example where the information recording apparatus 10 executes the reproduction mode in which an information process associated with presentation of information to the user is performed, the present invention is not limited to the case. For example, the mode executed by the information recording apparatus 10 during a coordinated operation may be a storage mode. Here, the storage mode is a mode in which the external device 20 can be connected to the information recording section 14 provided for the information recording apparatus 10 such that the external device 20 is possible to write or read data to/from the information recording section 14 and the reproduction mode is a mode executed in the external device 20. In such a configuration, the external device 20 performs an information process required to present information to the user, and it is thereby possible to reduce power consumption of the information recording apparatus 10. Furthermore, when the external device 20 is, for example, a smartphone, the user can cause the information recording apparatus 10 to record information acquired by the external device 20 and also use the information recording apparatus 10 as an external recording medium.

Note that although a case has been described in the present embodiment as an example where the external device 20 is one information terminal, the present invention is not limited to the case. For example, the external device 20 may also be composed of a combination of a display of an IoT device and a smartphone. With such a configuration, the user can view information recorded in the information recording apparatus 10 on a display by operating the smartphone.

Note that although a case has been described in the present embodiment as an example where the communication section 16 and the communication section 26 perform first communication and second communication, the present invention is not limited to the case. For example, the communication section 16 and the communication section 26 may be provided with a first communication section configured to perform first communication and a second communication section configured to perform second communication respectively. In this case, a power-saving communication standard such as Bluetooth low energy (BLE) may be used for the first communication and high-speed communication standard such as Wi-Fi may be used for the second communication. Furthermore, transmission of the information list carried out in step S106 is carried out, for example, through the second communication, but when the information list has a data capacity that can be transmitted by BLE, transmission of the information list may be carried out through the first communication carried out by the first communication section. By adopting such a configuration, the information recording system 1 or the information recording apparatus 10 according to the present embodiment can suppress power consumption during communication standby. It is thereby possible to achieve power saving and a weight reduction through a size reduction of batteries.

### [First Modification]

A modification (first modification) of the first embodiment of the present invention will be described. Here, differences from the first embodiment will be described and identical parts are assigned identical reference numerals and description of the parts will be omitted.

In the first embodiment, the information recording apparatus 10 has been described in which the information acquiring mode or the recording mode, which is the main function, is executed to acquire information speedily and without missing timing at normal starting, and on the other hand, when the information recording apparatus 10 is connected through communication from the external device 20 and power is turned on, the reproduction mode expressed as a sub function with respect to the main function is executed. Such an information recording apparatus 10 can be used even in a situation in which the user does not have the apparatus at hand, that is, the user cannot check the state of the information recording apparatus 10. However, when a coordinated operation is started and power of the information recording apparatus 10 is turned on, for example, the operation section 17 may come into contact with another object and the information recording apparatus 10 may conduct an operation unintended by the user depending on the situation in which the information recording apparatus 10 is disposed. For example, under a situation in which photographing or recording is prohibited, acquisition of information unintended by the user may be performed. In such acquisition of information, information may be acquired, which can possibly infringe upon copyright or privacy of other people. The information presentation section 15 provided for the information recording apparatus 10 is, for example, a display or speaker, and is an element in the information recording apparatus 10 to present information to the user. For the reason, in a situation in which the user has no information recording apparatus 10 at hand, a part of the information presentation section 15 that outputs information in the information recording apparatus 10 to the user need not be operated. Therefore, the information recording apparatus 10 will be described in the present modification, in which the reproduction mode which is a sub function is executed when the coordinated operation is started, instead of the information acquiring mode or the recording mode which is a main function and the functions of the information presentation section 15 and the operation section 17 are partially invalidated.

### <Configuration of Information Recording System>

The internal control circuit 11 provided for the information recording apparatus 10 according to the present modification is further provided with a function as a function restriction section. The function restriction section is configured to restrict the function of the information recording apparatus 10. The function restriction section is provided with functions as a power control section and a notification control section. The power control section is configured to control power supplied to the respective sections provided for the information recording apparatus 10. To restrict the functions of the information recording apparatus 10, the power control section controls power supplied to the information presentation section 15 and the operation section 17 and partially invalidates the functions of the information presentation section 15 and the operation section 17. The notification control section is configured to send a notification or give a warning to the user. The notification control section according to the present modification sends a notification to the user that the functions of, for example, the information presentation section 15 and the operation section 17 are partially invalidated.

### <Operation of Information Recording System>

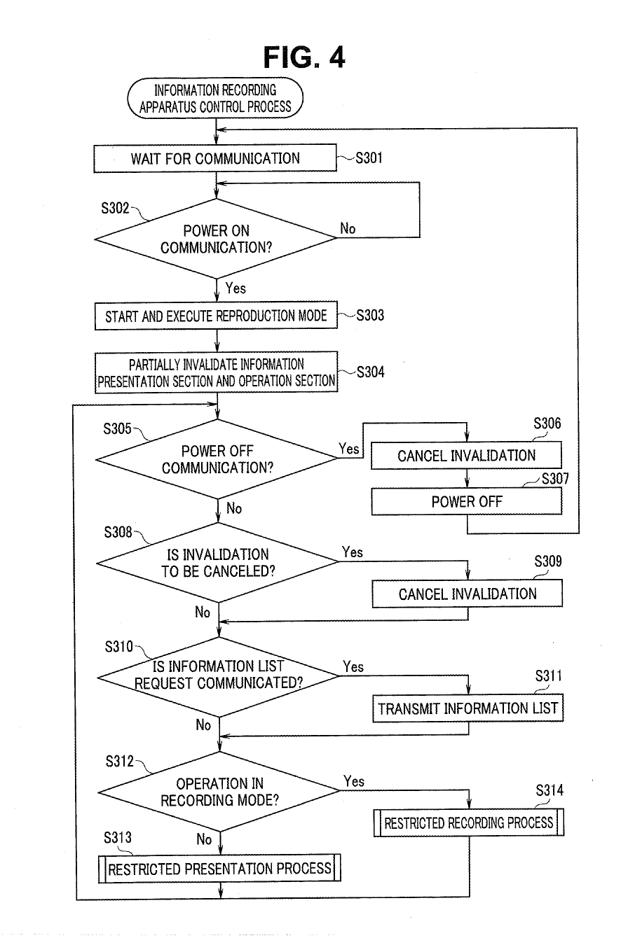

An example of the information recording apparatus control process carried out in the information recording apparatus 10 according to the present modification is shown in FIG. 4 as a flowchart. Here, operation of the information recording system 1 will be described while showing the correspondence between the information recording apparatus control process according to the present modification shown in FIG. 4 and the information recording apparatus control process according to the first embodiment shown in FIG. 2.

Processes in step S301 to step S303 are similar to the processes in step S101 and step S103 respectively. That is, the internal control circuit 11 waits until communication with the external device 20 is established in step S301 and determines whether or not power ON communication is received in step S302 after communication is established. The information recording apparatus control process repeats the process until it is determined that the power ON communication is received or proceeds to step S303 when such a determination is made. In step S303, the internal control circuit 11 causes the information recording apparatus 10 to start in the reproduction mode.

In step S304, the internal control circuit 11 executes a partial invalidation of the functions of the information presentation section 15 and the operation section 17. The internal control circuit 11, for example, controls the power supply and implements the partial invalidation. Furthermore, the internal control circuit 11 generates a control signal for sending notification to the user that the partial invalidation is executed and causes the communication section 16 to transmit the control signal to the external device 20. Note that the notification transmitted here is performed by the external device 20 when, the information list is presented in step 206 of the external device control process shown, for example, in FIG. 3.

In step S305, the internal control circuit 11 determines whether or not power OFF communication is received. The process in the present step is similar to the process in step S104. The information recording apparatus control process proceeds to step S306 when it is determined that power OFF communication is received or proceeds to step S308 when such a determination is not made.

In step S306, when the functions of the information presentation section 15 and the operation section 17 are partially invalidated, the internal control circuit 11 cancels the partial invalidation. Note that when the partial invalidation is not in progress, the process is not performed in the present step. After that, the information recording apparatus control process proceeds to step S307, turns off the power of the information recording apparatus 10 as in the case of step S105 and then returns to step S301.

In step S308, the internal control circuit 11 determines whether or not to cancel the partial invalidation. In the determination, the internal control circuit 11 determines that the partial invalidation is canceled, for example, when the operation section 17 detects the user operation or when a control signal for instructing cancellation of the partial invalidation is received from the external device 20. Note that the control signal for instructing the cancellation of partial invalidation is generated in accordance with the user operation after the external device 20 sends notification of partial invalidation in step 206 of the external device control process shown, for example, in FIG. 3. The information recording apparatus control process proceeds to step S309 when it is determined that the partial invalidation is canceled or proceeds to step S310 when such a determination is not made. In step S309, the internal control circuit 11 cancels the partial invalidation of the functions of the information presentation section 15 and the operation section 17. After that, the information recording apparatus control process proceeds to step S310.

The processes in step S310 to step S312 are similar to the processes in step S106 to step S108. That is, in step S310, the internal control circuit 11 determines whether or not information list request communication is received. The information recording apparatus control process proceeds to step S311 when it is determined that the information list request communication is received or proceeds to step S312 when such a determination is not made. In step S311, the internal control circuit 11 transmits the information list to the external device 20. In step S312, the internal control circuit 11 determines whether or not an instruction for transition to the recording mode is received. The information recording apparatus control process proceeds to step S314 when it is determined that the instruction for transition to the recording mode is received or proceeds to step S313 when such a determination is not made.

In step S313, the internal control circuit 11 performs a restricted presentation process. The restricted presentation process is the presentation process in step S109 carried out when the functions of the information presentation section 15 and the operation section 17 are partially invalidated. In the restricted presentation process, the internal control circuit 11 further determines whether or not the partial invalidation is executed. When it is determined that the partial invalidation is executed, the presentation process based on the output of the operation section 17 provided for the information recording apparatus 10 is not performed in the restricted presentation process. After the end of the restricted presentation process, the information recording apparatus control process returns to step S305.

In step S314, the internal control circuit 11 executes a restricted recording process. The restricted recording process is the recording process in S110 that can be executed in a state in which the functions of the information presentation section 15 and the operation section 17 are partially invalidated. In the restricted recording process, the internal control circuit 11 further determines whether or not it is a state where the partial invalidation is executed. When it is determined that partial invalidation is executed, the recording process based on the output of the operation section 17 provided for the information recording apparatus 10 is not executed in the restricted recording process. After the end of the restricted recording process, the information recording apparatus control process returns to step S305.

### <Advantage of Information Recording System>

The information recording apparatus 10 according to the present modification has the following advantages in addition to the advantages obtained in the first embodiment. When communication with the external device 20 is established, the information recording apparatus 10 according to the present modification executes partial invalidation of the functions of the information presentation section 15 and the operation section 17 in addition to the selection of the reproduction mode as the mode to be executed at the start of a coordinated operation. In this way, the information recording apparatus 10 according to the present embodiment can prevent presentation of information to the user from being started due to misoperation at timing and in a place unintended by the user or prevent recording of information from being started. Therefore, the user can check information recorded in the information recording apparatus 10 through a coordinated operation even in a place where recording operation such as photographing or sound recording is prohibited. Furthermore, the user can use the information recording system 1 while preventing an unintended presentation operation or recording operation from being performed in the information recording apparatus 10, consuming power or reducing a battery remaining amount or reducing an amount of recordable data.

When partial invalidation is executed through the coordinated operation and the functions are restricted, the information recording apparatus 10 according to the present modification causes the external device 20 to perform part of the invalidated functions such as presentation of information to the user. For the reason, the user can use a desired function even when partial invalidation is executed.

Furthermore, the information recording apparatus 10 according to the present modification executes partial invalidation by controlling the power supply. Therefore, the user can use the information recording system 1 while preventing power from being consumed for the functions not used in the information recording apparatus 10 during a coordinated operation, causing a reduction of the remaining amount of the battery.

### Second Embodiment

A second embodiment of the present invention will be described. Here, differences from the modification (first modification) of the first embodiment will be described and identical parts are assigned identical reference numerals and description of the parts will be omitted.

In the first modification, the information recording apparatus 10 has been described in which when the information recording apparatus 10 is started normally, the information acquiring mode or the recording mode which is the main function is executed for speedy acquisition of information without missing timing, and on the other hand, when power is turned on by being connected from the external device 20 through communication, the reproduction mode which is expressed as a sub function with respect to the main function is executed and the functions of the information presentation section 15 and the operation section 17 are partially invalidated. Such an information recording apparatus 10 can prevent the user from unintentionally acquiring information that may possibly infringe upon the copyright or privacy of other people. On the other hand, in the information recording apparatus 10, even in a situation in which the user can operate both the information recording apparatus 10 and the external device 20, for example, in a situation in which the user has the information recording apparatus 10 and the external device 20 at hand, the functions of the information presentation section 15 and the operation section 17 may be partially invalidated. Moreover, the user may perform a recording operation at the information recording apparatus 10 through a remote operation through communication. In such a case, the user can determine whether or not photographing or sound recording is prohibited. On the other hand, for example, the information recording apparatus 10 may be placed, for example, in a bag and the information recording apparatus 10 may be in contact with other articles in the bag. In such a case, if the information recording apparatus 10 has some parts that displace or deform along with the operation associated with the recording mode, the other articles may prevent displacement or deformation. Depending on the condition in which the information recording apparatus 10 is placed, normal recording operation is not possible or a load exceeding a design value may be imposed on the displacing or deforming locations, causing a malfunction. Thus, in the present embodiment, the information recording apparatus 10 will be described which acquires a condition of the information recording apparatus 10 and determines based on the acquired condition, whether or not to partially invalidate the functions of the information acquisition section 12, information presentation section 15 and the operation section 17.

Note that in the present embodiment, the information recording system 1 will be described more specifically using a case where the information recording apparatus 10 is an image pickup apparatus and the external device 20 is a smartphone as an example. As in the case of the information recording apparatus according to the first modification, the image pickup apparatus according to the present embodiment is provided with functions of an information acquiring mode to pick up and acquire an image or a movie or a photographing mode to record a picked-up image or a movie and a reproduction mode to reproduce a recorded image or movie. In such an image pickup apparatus, the function associated with speedy acquisition of information without missing timing (function of the information acquiring mode or photographing mode) is the main function and the function associated with reproduction of an image or the like which may be performed by an external device (function of the reproduction mode) is a sub function. Thus, when the image pickup apparatus is started, the information acquiring mode or the photographing mode is normally preferentially executed. A specification of the camera 100 that can execute the function of the information acquiring mode or the photographing mode which is the main function when power is turned on through communication is also possible, but such a specification may not be preferred because the function may be executed in a situation in which photographing is prohibited or a work, a copyright of which is not held by the user, is recorded.

Note that the acquired information is not limited to an image or a movie acquired by image pickup but may be a result obtained by analyzing an image or a movie acquired by image pickup. Furthermore, the image pickup apparatus may also be such an inspection apparatus that acquires an image or a movie by image pickup, analyzes the acquired image or movie, acquires other information from the analysis result and records the information obtained. However, a case will be described as an example below where an image is acquired by image pickup, that is, the photographing mode is a mode in which an image acquired by image pickup is recorded.

The reproduction mode is a function that prohibits operation associated with acquisition of information and allows the user to check the information recorded in the information recording apparatus 10, that is, a function that makes information reproducible as in the case of the first modification. The function in the reproduction mode is a function that makes reproducible, information recorded in the photographing mode which is the main function or information recorded in the image pickup apparatus, and not a function that executes reproduction for checking a live view image or the like during photographing. Furthermore, the function in the reproduction mode which is the sub function is a function that causes recording information such as an image to be displayed on a display of the image pickup apparatus or a smartphone. The information displayed here is not limited to an image but may also be voice or information acquired through an analysis of the information obtained. As examples of features of the function of the reproduction mode, an image picked up and recorded may be displayed as a thumbnail image on a display of an image pickup apparatus or a smartphone or may be displayed as an enlarged reproduction image.

### <Configuration of Information Recording System>

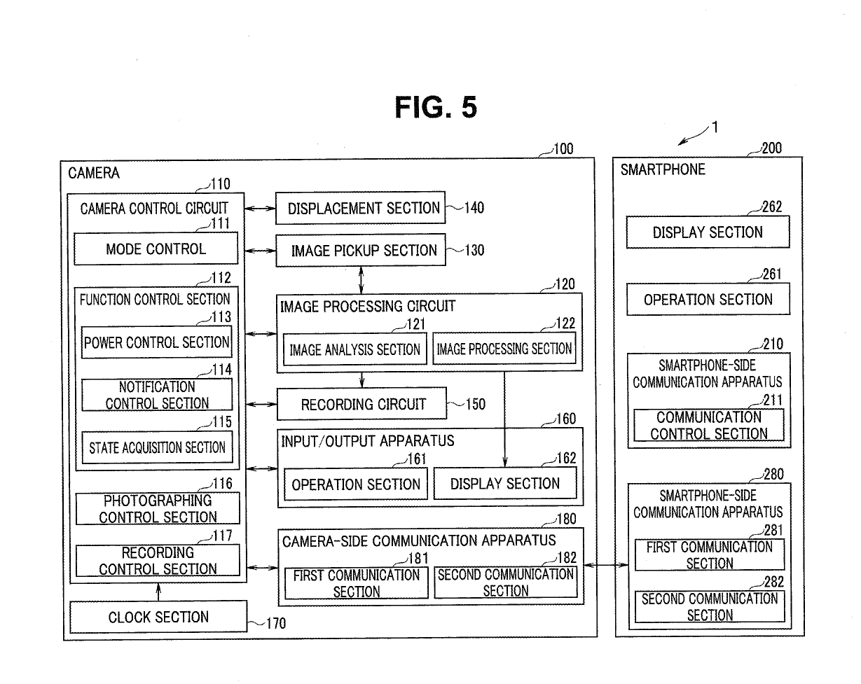

A schematic configuration example of the information recording system 1 according to the present embodiment is shown in FIG. 5 as a block diagram. As shown in FIG. 5, the information recording system 1 according to the present embodiment includes a camera 100 as an example of the information recording apparatus 10 and a smartphone 200 as an example of the external device 20.

The camera 100 is provided with a camera-side control circuit 110, an image processing circuit 120, an image pickup section 130, a displacement section 140, a recording circuit 150, an input/output apparatus 160, a clock section 170 and a camera-side communication apparatus 180.

The camera-side control circuit 110 is configured to control operations of the respective sections provided for the camera 100. The camera-side control circuit 110 is configured to acquire various types of information associated with operation of the camera 100 and make various types of determination associated with operation of the camera 100. The camera-side control circuit 110 is provided with functions as a mode control section 111, a function restricting section 112, a photographing control section 116 and a recording control section 117. The mode control section 111 corresponds to the mode control section 11 a provided for the information recording apparatus 10 according to the first modification. The function restricting section 112 corresponds to the function as the function restriction section provided for the information recording apparatus 10 according to the first modification and is configured to partially invalidate the respective sections provided for the camera 100 and restrict the functions of the camera 100. The function restricting section 112 is provided with functions as a power control section 113 and a notification control section 114. The power control section 113 and the notification control section 114 correspond to the functions as the power control section and the notification control section provided for the information recording apparatus 10 according to the first modification, respectively. The function restricting section 112 according to the present embodiment is further provided with a state acquisition section 115. The state acquisition section 115 is configured to acquire a situation surrounding the camera 100 and acquire a state of the camera 100 as state information. The photographing control section 116 is configured to control operation of the image pickup section 130 and cause the image pickup section 130 to acquire an image. The photographing control section 116 is configured, for example, to cause a focusing lens included in an image pickup optical system provided for the image pickup section 130 to move in an optical axis direction to adjust focusing, control operation of an aperture provided for the image pickup section 130 to adjust exposure or control operation in an optical axis direction of a zoom lens provided for the image pickup section 130 to adjust zooming. The recording control section 117 is configured to control recording operation of the camera 100.

The image processing circuit 120 is configured to apply various types of image processing to an image acquired in the image pickup section 130. Data subjected to the image processing by the image processing circuit 120 is, for example, recorded in the recording circuit 150 or transmitted to the smartphone 200. The image processing circuit 120 is provided with functions as an image analysis section 121 and an image processing section 122. The image analysis section 121 is configured to make various types of analyses based on the image acquired. The analysis results from the image analysis section 121 are outputted in the state acquisition section 115 or recorded in the recording circuit 150. The function as the image analysis section 121 may also be provided for the state acquisition section 115. The image processing section 122 is provided with a function as an effect processing section that adds a predetermined effect to an image and a function as a compression processing section that applies compression processing to generate an image to be displayed or an image to be recorded and configured to apply various types of image processing to the image obtained.

The image pickup section 130 includes, for example, an image pickup optical system and an image pickup device and configured to generate an image based on an image formed on an image pickup surface of an image pickup device via an image pickup optical system. Furthermore, the image pickup section 130 may also be provided with an illumination section configured to radiate illumination light or auxiliary light during image pickup. The image pickup section 130 corresponds to the information acquisition section 12 according to the first modification. The displacement section 140 includes each section provided for the camera 100, a position or shape of which is configured to be changeable, for example, displaceable or deformable. The displacement section 140 includes a lens and a lens cover or the like. The recording circuit 150 records programs, various parameters used in each section provided for the camera 100 and data acquired in the camera 100. The recording circuit 150 temporarily records various types of data, such as images (pixel data), images to be recorded, images to be displayed, output of the state acquisition section 115 and processing data during operation. The input/output apparatus 160 is provided with an operation section 161 and a display section 162. The operation section 161 corresponds to the operation, section 17 according to the first modification and acquires results of the user operation. The operation section 161 includes a release button and a touch panel or the like. The display section 162 corresponds to the information presentation section 15 according to the first modification and includes, for example, a liquid crystal display. The clock section 170 is configured to output time information to the camera-side control circuit 110. The camera-side communication apparatus 180 is provided with a first communication section 181 and a second communication section 182. The first communication section 181 and the second communication section 182 correspond to the first communication section carrying out first communication and the second communication section carrying out second communication respectively, that can be provided for the communication section 16 according to the first modification.

The smartphone 200 is provided with a smartphone-side control circuit 210, an operation section 261, a display section 262, and a smartphone-side communication apparatus 280. Note that the smartphone 200 may further be provided with a smartphone-side recording circuit configured to record various types of information.

The smartphone-side control circuit 210 corresponds to the external control circuit 21 according to the first modification and is configured to control operations of the respective sections provided for the smartphone 200. The smartphone-side control circuit 210 is configured to acquire various types of information associated with operation of the smartphone 200 and make various types of determinations. The smartphone-side control circuit 210 is provided with a communication control section 211. The communication control section 211 is configured to control communication carried out between the smartphone-side communication apparatus 280 and the camera-side communication apparatus 180 provided for the camera 100.

The operation section 261 corresponds to the operation section 27 according to the first modification, includes, for example, a touch panel and a button and is configured to acquire results of the user's operations on the smartphone 200. The operation section 261 may include a switch, a dial, a keyboard, a mouse or the like. The display section 262 corresponds to the information presentation section 25 according to the first modification and includes, for example, a liquid crystal display. The smartphone-side communication apparatus 280 is provided with a first communication section 281 and a second communication section 282. The first communication section 281 and the second communication section 282 correspond to the first communication section that carries out first communication and the second communication section that carries out second communication respectively, that can be provided for the communication section 26 according to the first modification.

Note that the camera-side control circuit 110, the image processing circuit 120 and the smartphone-side control circuit 210 include an integrated circuit such as central processing unit (CPU), an application specific integrated circuit (ASIC) or a field programmable gate array (FPGA). The camera-side control circuit 110, the image processing circuit 120 and the smartphone-side control circuit 210 may be composed of one integrated circuit or the like respectively or may be composed of a combination of a plurality of integrated circuits or the like. Furthermore, the camera-side control circuit 110 and the image processing circuit 120 may be composed of one integrated circuit or the like. Each section provided for the camera-side control circuit 110 may be composed of one integrated circuit or the like or may be composed of a combination of a plurality of integrated circuits or the like. Moreover, two or more of the respective sections provided for the camera-side control circuit 110 may be composed of one integrated circuit or the like. Each section provided for the image processing circuit 120 may be composed of one integrated circuit or the like or may be composed of a combination of a plurality of integrated circuits. Moreover, two or more of the respective sections provided for the image processing circuit 120 may be composed of one integrated circuit or the like. Similarly, the smartphone-side control circuit 210 and the communication control section 211 of the smartphone-side control circuit 210 may be composed of one integrated circuit or the like respectively or may be composed of a combination of a plurality of integrated circuits. The smartphone-side control circuit 210 and the communication control section 211 of the smartphone-side control circuit 210 may be composed of one integrated circuit or the like. Operations of the integrated circuits are performed according to a program recorded in a recording region, for example, in the recording circuit 150 or the smartphone-side recording circuit or the integrated circuit.

Note that the recording circuit 150, the smartphone-side recording circuit or the respective elements provided for the circuits are non-volatile memories such as flash memories, but may be further provided with volatile memories such as a static random access memory (SRAM) or a dynamic random access memory (DRAM). Furthermore, the recording circuit 150 or each element provided for the recording circuit 150 and the smartphone-side recording circuit or each element provided for the smartphone-side recording circuit may be composed of one memory or the like respectively or may be composed of a combination of a plurality of memories or the like. Moreover, a data server or the like located outside the information recording system may be used as part of the memory.

### <Overview of Operation of Information Recording System>

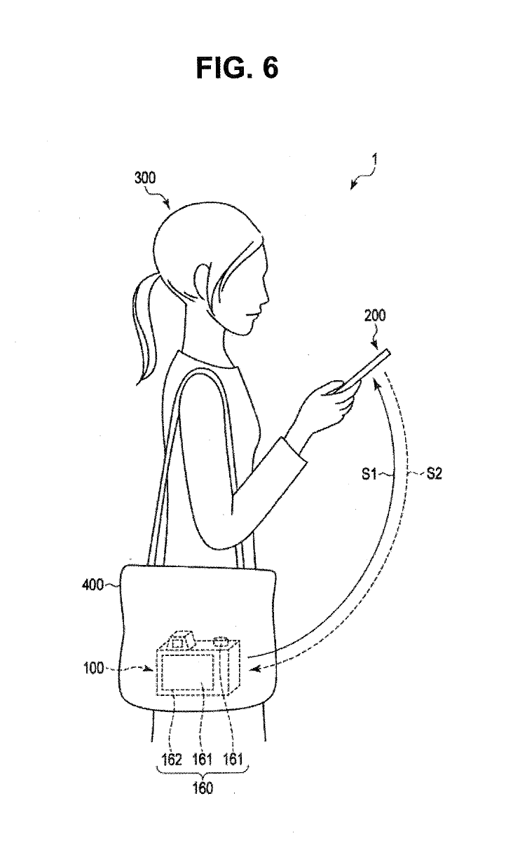

Here, an example of a scene in which the information recording system 1 according to the present embodiment is used is shown in FIG. 6 as a schematic diagram. Note that the camera 100 according to the present embodiment starts a coordinated operation by executing the reproduction mode when power is turned on through communication, but the mode executed during the coordinated operation is not limited to the reproduction mode. It is also important that the photographing mode be executed through the coordinated operation.

For example, in the scene shown in FIG. 6, the camera 100 is placed in a bag 400 of a user 300. Furthermore, the user 300 can operate the operation section 261 while viewing the display section 262 of the smartphone 200. For example, when the user 300 operates the smartphone 200 and a coordinated operation between the camera 100 and the smartphone 200 is started, the camera 100 executes the reproduction mode as in the case of the first modification. At this time, the state acquisition section 115 provided for the camera 100 according to the present embodiment acquires the state in which the camera 100 is disposed as state information. The camera 100 according to the present embodiment determines whether or not the camera 100 is disposed in the bag 400 based on the state information. For example, as shown in FIG. 6, in the state in which the camera 100 is disposed in the bag 400, the operation section 161 and the display section 162 of the camera 100 need not operate, and moreover if the displacement section 140 operates, an unnecessary load is produced, which may cause a malfunction of the camera 100.

Thus, the camera 100 according to the present embodiment restricts operations of the operation section 161, the display section 162 and the displacement section 140 according to the state of the camera 100 and partially invalidates the functions of the operation section 161, the display section 162 and the image pickup section 130. Moreover, the camera 100 performs communication S1 to send a notification to the user 300 that partial invalidation is executed. In this way, even when the user 300 performs communication S2 to instruct an operation which may cause a malfunction, it is possible to prevent the camera 100 from malfunctioning. Note that through communication S1, state information may be transmitted from the camera 100 to the smartphone 200 and a control signal for partial invalidation may be transmitted from the smartphone 200 to the camera 100 through communication S2.

### <Operation of Information Recording System>

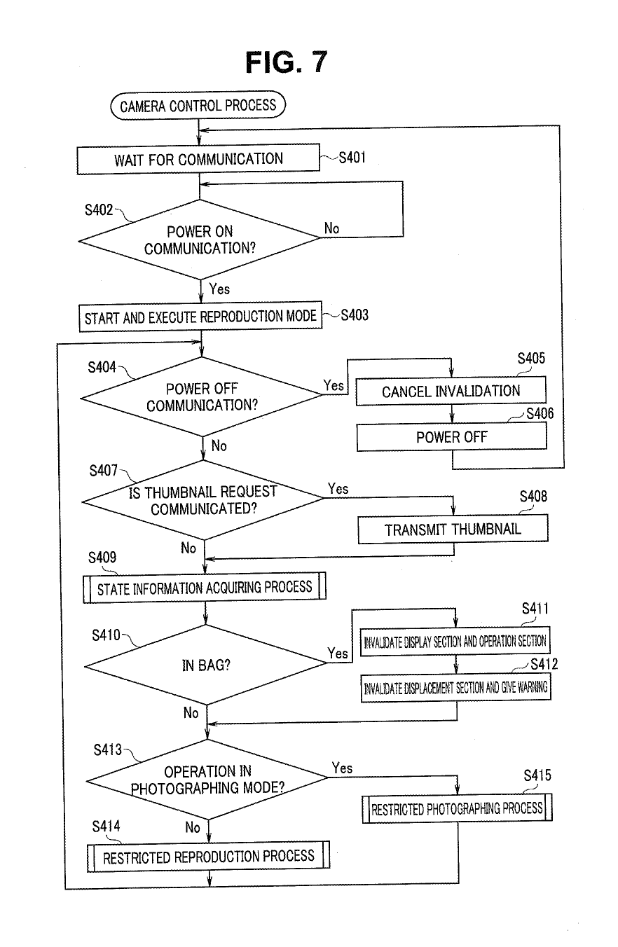

An example of the camera control process carried out by the camera 100 is shown in FIG. 7 as a flowchart and operation of the information recording system 1 will be described with reference to the flowchart. Here, operation of the information recording system 1 will be described while showing a correspondence between a camera control process according to the present embodiment shown in FIG. 7 and the information recording apparatus control process according to the first modification shown in FIG. 4.

Processes in step S401 to step S403 are similar to the processes in step S301 to step S303 respectively. That is, in step S401, the camera-side control circuit 110 waits until communication with the smartphone 200 is established and determines in step S402 whether or not power ON communication is received after communication is established. The camera control process repeats the process until it is determined that power ON communication is received, or proceeds to step S403 when such a determination is made. In step S403, the camera-side control circuit 110 causes the camera 100 to start in the reproduction mode.

Processes in step S404 to step S406 are similar to the processes in step S305 to step 307 respectively. That is, in step S305, the camera-side control circuit 110 determines whether or not power OFF communication is received. When the power OFF communication is received and if partial invalidation is in progress in step S405, the camera-side control circuit 110 cancels the partial invalidation and then turns off power of the camera 100 in step S406. The camera control process proceeds to step S407 when it is not determined that the power OFF communication is received.

Processes in step S407 and step S408 are similar to the processes in step S310 and step S311 respectively. That is, in step S407, the camera-side control circuit 110 determines whether or not thumbnail request communication is received. Note that thumbnail images showing images or the like recorded in the recording circuit 150 correspond to the information list in the first modification. The camera control process proceeds to step S408 when it is determined that the thumbnail request communication is received or proceeds to step S409 when such a determination is not made. In step S408, the camera-side control circuit 110 transmits the thumbnail images to the smartphone 200. After that, the camera control process proceeds to step S409. Note that although a case will be described in the present embodiment where thumbnail images are transmitted through first communication, but the present invention is not limited to the case. For example, when the thumbnail request communication is received, the camera 100 may operate so that second communication with the smartphone 200 is established and may transmit the thumbnail images through second communication.

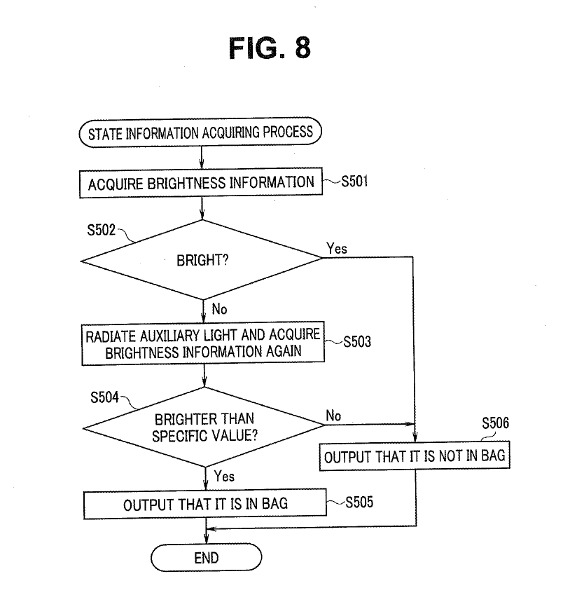

In step S409, the camera-side control circuit 110 performs a state information acquiring process to acquire the state of the camera 100 as state information. Here, an example of the state information acquiring process according to the present embodiment is shown in FIG. 8 as a flowchart.

Since the state of the camera 100 is unclear, the camera-side control circuit 110 causes, in step S501, the image pickup section 130 to pick up and acquire an image so as not to cause the displacement section 140 to operate, causes the image processing circuit 120 to analyze the acquired image and acquire brightness of the acquired image as state information. In step S502, the camera-side control circuit 110 determines whether or not the acquired image is brighter than a predetermined threshold based on the state information. The state information acquiring process proceeds to step S506 when it is determined that the acquired image is brighter than the predetermined threshold or proceeds to step S503 when such a determination is not made.

In step S503, the camera-side control circuit 110 causes the image pickup section to acquire an image again while radiating auxiliary light such as a flash. The camera-side control circuit 110 causes the image processing circuit 120 to analyze the acquired image and acquires the brightness of the acquired image as state information again. In step S504, the camera-side control circuit 110 determines whether or not the acquired image is brighter than a specific threshold based on the state information acquired again. The state information acquiring process proceeds to step S505 when it is determined that the acquired image is brighter than a specific threshold or proceeds to step S506 when such a determination is not made.

Since the situation surrounding the camera 100 is dark and some object scattering auxiliary light exists, the camera-side control circuit 110 outputs that the camera 100 is in the bag to the state acquisition section 115 in step S505. After that, the state acquiring process ends and the camera control process proceeds to step S410.

Since the situation surrounding the camera 100 is bright or dark but no object scattering auxiliary light exists in that situation, the camera-side control circuit 110 outputs that the camera 100 is not in the bag to the state acquisition section 115 in step S506. After that, the state acquiring process ends and the process proceeds to step S410 of the camera control process.

With reference to FIG. 7 again, the camera control process after acquisition of the state information will be described. In step S410, the camera-side control circuit 110 determines whether or not the camera 100 is in the bag based on the acquired state information. The camera control process proceeds to step S411 when it is determined that the camera 100 is in the bag or proceeds to step S413 when such a determination is not made.

In step S411, the camera-side control circuit 110 partially invalidates the functions of the operation section 161 and the display section 162. The process in the present step is similar to the process in step S309. In step S412, the camera-side control circuit 110 partially invalidates the operation of the displacement section 140 and restricts the function of the image pickup section 130. The camera-side control circuit 110 causes the first communication section 181 to transmit to the smartphone 200, a control signal for notifying the user that the operation of the displacement section 140 is partially invalidated and the function of the image pickup section 130 is restricted. Therefore, the user can easily grasp that the operation of the displacement section 140 is restricted. Note that when the operation of the displacement section 140 is partially invalidated, the camera-side control circuit 110 may generate a control signal for partially invalidating the user operation in the smartphone 200 and cause the first communication section 181 to transmit the control signal to the smartphone 200. In this case, even when the user selects the restricted function from the smartphone 200, it is possible to prevent the displacement section 140 from operating, causing a malfunction. Therefore, the user can easily grasp that the operation of the smartphone 200 associated with the operation of the displacement section 140 is restricted, and so even when the operation of the smartphone 200 is suddenly invalidated, the user can use a coordinated operation without confusion.

Processes in step S413 to step S415 are similar to the processes in step S312 to step S314 respectively. That is, in step S413, the camera-side control circuit 110 determines whether or not an instruction for transition to the photographing mode is received. The camera control process proceeds to step S415 when it is determined that an instruction for transition to the photographing mode is received and executes the restricted photographing process, or proceeds to step S414 when such a determination is not made and executes the restricted reproduction process.

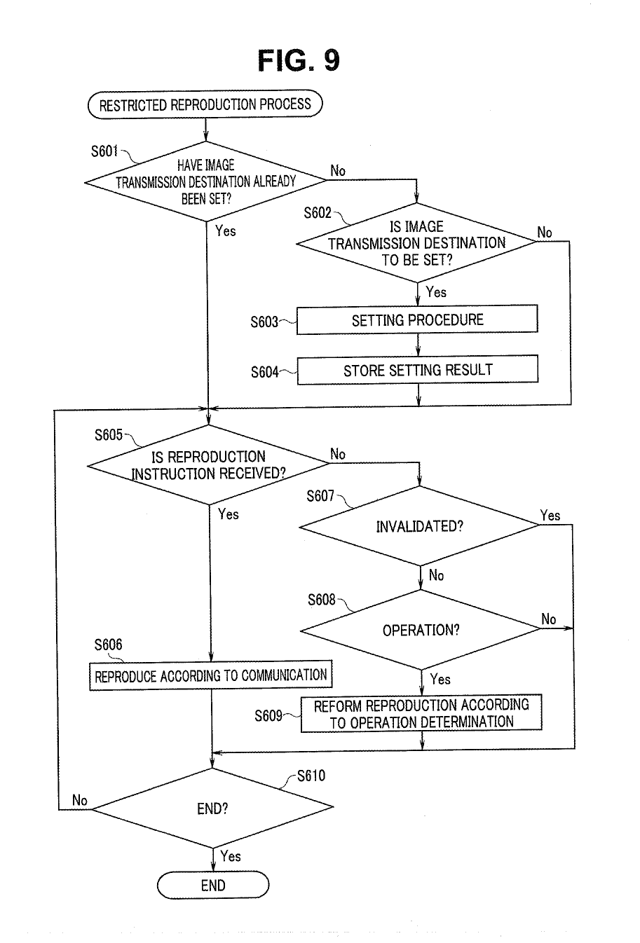

Here, an example of the restricted reproduction process executed in step S414 of the camera control process is shown in FIG. 9 as a flowchart, and operation of the information recording system 1 will be described more specifically.

In step S601, the camera-side control circuit 110 determines whether or not the transmission destination of an acquired image or the like, that is, the communication destination during a coordinated operation is already set. The restricted reproduction process proceeds to step S605 when it is determined that the communication destination is already set or proceeds to step S602 when such a determination is not made. In step S602, the camera-side control circuit 110 determines whether or not to set the communication destination based on the result of the user operation acquired from, for example, the smartphone 200. The restricted reproduction process proceeds to step S603 when it is determined that the communication destination is set or proceeds to step S605 when such a determination is not made. In step S603, the camera-side control circuit 110 performs a setting procedure about the communication destination during a coordinated operation based on the result of the user operation acquired from, for example, the smartphone 200. In step S604, the camera-side control circuit 110 records the setting result of the set communication destination, for example, in the recording circuit 150. After that, the restricted reproduction process proceeds to step S605.

In step S605, the camera-side control circuit 110 determines whether or not a reproduction instruction for instructing transmission of the reproduction information is received from the smartphone 200. The restricted reproduction process proceeds to step S606 when it is determined that the reproduction instruction is received or proceeds to step S607 when such a determination is not made. In step S606, the camera-side control circuit 110 causes the second communication section 182 to transmit the reproduction information to the smartphone 200 in accordance with the reproduction instruction. Note that the second communication is established prior to the transmission of the reproduction information in the present step. After that, the restricted reproduction process proceeds to step S610.

In step S607, the camera-side control circuit 110 determines whether or not the function of the operation section 161 is partially invalidated. The restricted reproduction process proceeds to step S610 when it is determined that the partial invalidation is executed or proceeds to step S608 when such a determination is not made. In step S608, the camera-side control circuit 110 determines whether or not the operation section 161 provided for the camera 100 detects the user operation associated with information reproduction. For example, by operating, for example, the operation section 161, the user selects information to be transmitted to the smartphone 200 or selects information to be reproduced in the camera 100. The restricted reproduction process proceeds to step S609 when it is determined that the operation section 161 detects the user operation or proceeds to step S610 when such a determination is not made. In step S609, the camera-side control circuit 110 causes the display section 162 to output reproduction information of an image or the like or causes the second communication section 182 to transmit the reproduction information to the smartphone 200 in accordance with the result of the user operation acquired by the operation section 161. After that, the restricted reproduction process proceeds to step S610.

In step S610, the camera-side control circuit 110 determines whether or not to end the restricted reproduction process based on, for example, the result of the user operation. The result of the user operation may be, for example, detected by the operation section 161 or acquired by the first communication section 181 through communication. When the reproduction of the reproduction information of a movie or the like ends, and when a predetermined time period elapses after the reproduction starts, it can be determined that the reproduction ends. The restricted reproduction process returns to step S605 when it is not determined that the reproduction of the reproduction information ends, or the restricted reproduction process ends and the process returns to step S401 of the camera control process when such a determination is made.

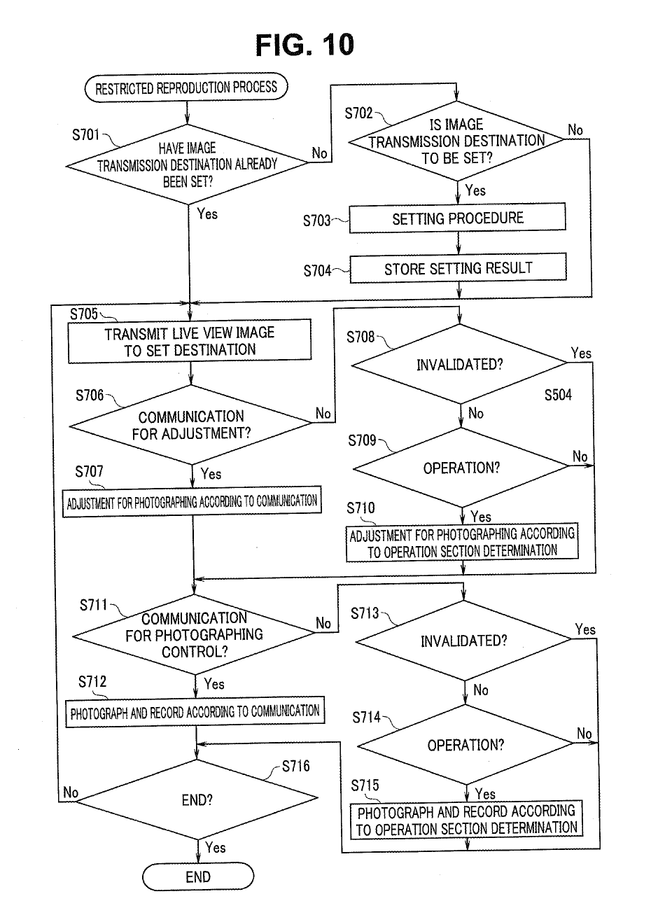

Here, an example of a restricted photographing process carried out in step S415 of the camera control process is shown in FIG. 10 as a flowchart and operation of the information recording system 1 will be described more specifically.

Processes in step S701 to step S704 are similar to the processes in step S601 to step S604 of the restricted reproduction process. That is, in step S701, the camera-side control circuit 110 determines whether or not the communication destination during a coordinated operation is already set. The restricted recording process proceeds to step S705 when it is determined that the communication destination is already set or proceeds to step S702 when such a determination is not made. In step S702, the camera-side control circuit 110 determines whether or not to set a communication destination. The restricted recording process proceeds to step S703 when it is determined that the communication destination is set or proceeds to step S705 when such a determination is not made. In step S703, the camera-side control circuit 110 executes a setting procedure about the communication destination during a coordinated operation and records the setting result, for example, in the recording circuit 150 in step S704. After that, the restricted recording process proceeds to step S705. In step S705, the camera-side control circuit 110 causes the image pickup section 130 to start image pickup for a live view image. The camera-side control circuit 110 causes the second communication section 182 to transmit the live view image to the smartphone 200. Note that second communication is established prior to the transmission of the live view image in the present step.

In step S706, the camera-side control circuit 110 determines whether or not communication for adjustment is received from the smartphone 200. The communication for adjustment includes a control signal for instructing adjustment of various parameters associated with operation of the camera 100 in the photographing mode. For example, the communication for adjustment includes a control signal for adjusting focusing. Furthermore, when, for example, information to be acquired is a movie, the communication for adjustment includes a control signal for setting a movie compression method or the like. The restricted photographing process proceeds to step S707 when it is determined that the communication for adjustment is received or proceeds to step S708 when such a determination is not made. In step S707, the camera-side control circuit 110 adjusts and sets the various parameters associated with the operation of the camera 100 in the photographing mode in accordance with the adjustment instruction received through the communication for adjustment. After that, the restricted photographing process proceeds to step S711. The processes in step S708 and step S709 are similar to the processes in step S607 and step S608 of the restricted reproduction process. That is, in step S708, the camera-side control circuit 110 determines whether or not to execute partial invalidation. The restricted recording process proceeds to step S711 when it is determined that partial invalidation is executed or proceeds to step S709 when such a determination is not made. In step S709, the camera-side control circuit 110 determines the presence or absence of output of the operation section 161 in accordance with the user operation. The restricted recording process proceeds to step S710 when it is determined that output of the operation section 161 is detected or proceeds to step S711 when such a determination is not made. In step S710, the camera-side control circuit 110 adjusts and sets various parameters associated with the operation of the camera 100 in the photographing mode in accordance with the results of the user operation acquired by the operation section 161. After that, the restricted reproduction process proceeds to step S711.

In step S711, the camera-side control circuit 110 determines whether or not communication for photographing control is received from the smartphone 200. The communication for photographing control includes a control signal for controlling a photographing operation of the camera 100 in the photographing mode. The restricted photographing process proceeds to step S712 when it is determined that the communication for photographing control is received or proceeds to step S713 when such a determination is not made. In step S712, the camera-side control circuit 110 causes the image pickup section 130 to start image pickup in accordance with a photographing command signal received through communication for photographing control and causes the recording circuit 150 to record the acquired image. However, when partial invalidation of the displacement section 140 is executed, the camera-side control circuit 110 does not allow the displacement section 140 to operate or limits the operation range of the displacement section 140 to a predetermined range. After that, the restricted photographing process proceeds to step S716. The processes in step S713 and step S714 are similar to the processes in step S708 and step S709. That is, in step S713, the camera-side control circuit 110 determines the presence or absence of partial invalidation. The restricted recording process proceeds to step S716 when it is determined that partial invalidation is executed or proceeds to step S714 when such a determination is not made. In step S714, the camera-side control circuit 110 determines the presence or absence of output of the operation section 161 in accordance with the user operation. The restricted recording process proceeds to step S715 when it is determined that the output of the operation section 161 is detected or proceeds to step S716 when such a determination is not made. In step S715, the camera-side control circuit 110 causes the image pickup section 130 to start image pickup in accordance with the user operation acquired by the operation section 161 and causes the recording circuit 150 to record the acquired image. However, when partial invalidation of the displacement section 140 is executed, the camera-side control circuit 110 does not allow the displacement section 140 to operate or limits the operation range of the displacement section 140 to a predetermined range. For example, when it is determined that the camera 100 is in the bag, the camera-side control circuit 110 prohibits operation of the zoom lens during photographing. After that, the restricted photographing process proceeds to step S716.

In step S716, the camera-side control circuit 110 determines whether or not to end the restricted photographing process in accordance with, for example, the user operation. The user operation may be detected by the operation section 161 or acquired by the first communication section 181 through communication. The restricted photographing process returns to step S705 when it is not determined that the restricted photographing process is ended or ends the process and returns to step S401 of the camera control process when it is determined that the restricted photographing process is ended.

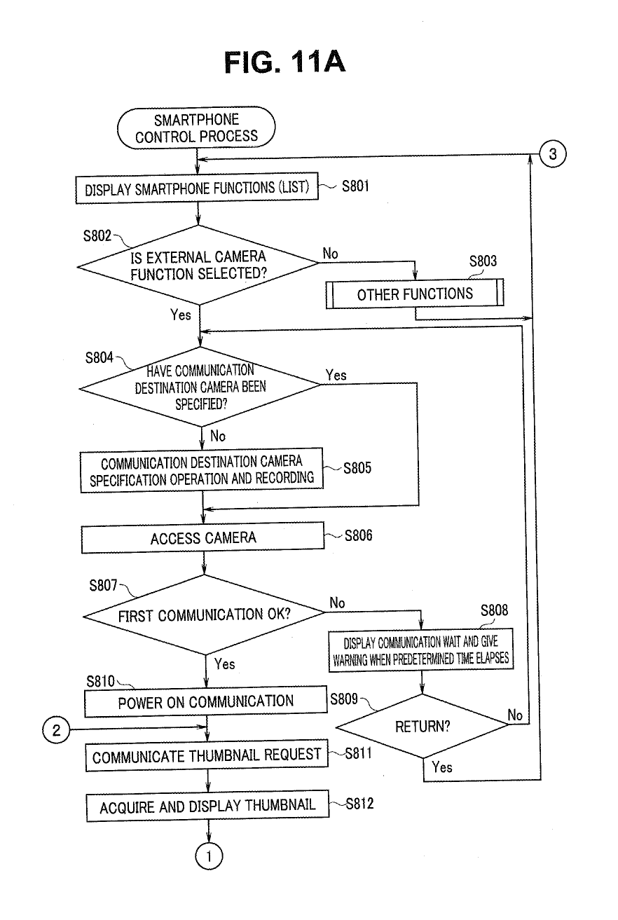

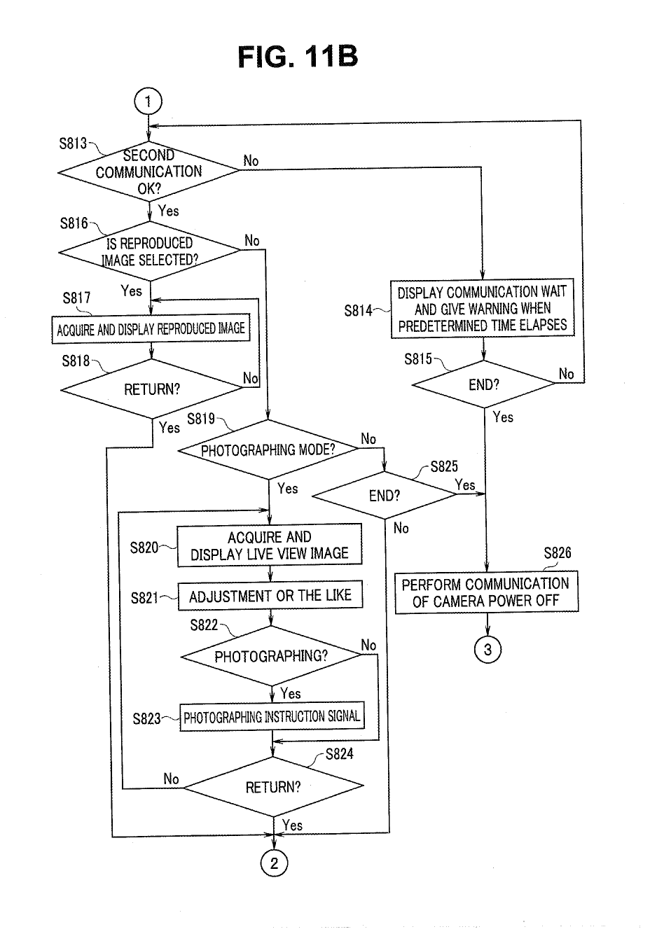

An example of the smartphone control process carried out in the smartphone 200 is shown in FIG. 11A and FIG. 11B as a flowchart and operation of the information recording system 1 will be described with reference to the flowchart. Note that the description hereinafter will focus on differences from an example of the external device control process according to the first embodiment applied to the first modification shown in FIG. 5A and FIG. 5B.

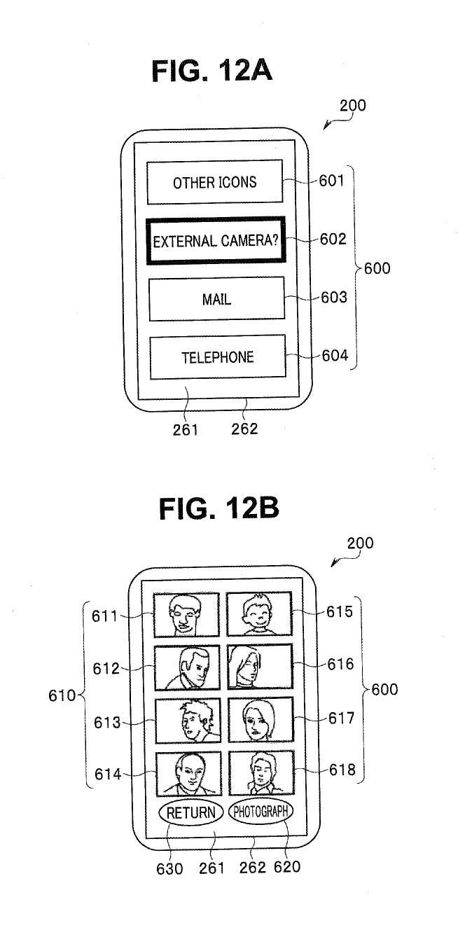

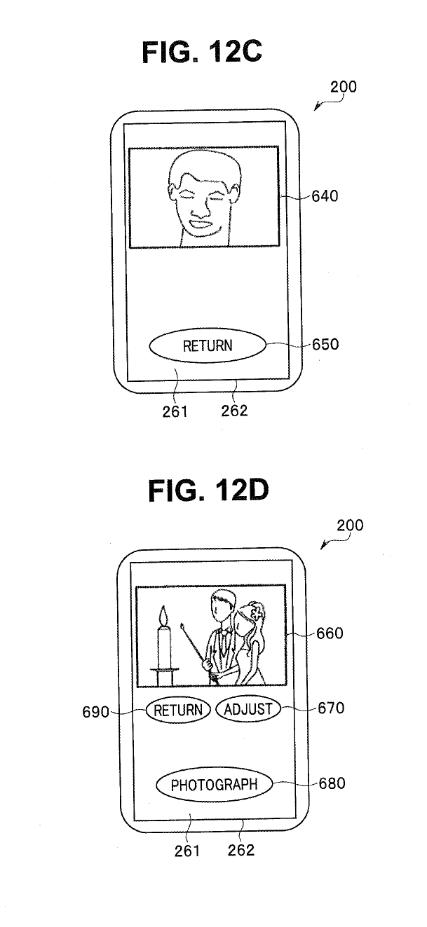

In step S801, the smartphone-side control circuit 210 causes the display section 162 to display a list of functions provided for the smartphone 200. FIG. 12A illustrates an example of a display of the display section 162 at this time as a schematic diagram. As shown in FIG. 12A, a display section 262 displays an icon group 600 showing functions provided for the smartphone 200 such as an icon 601 showing display of other icons, an icon 602 showing an external camera function, an icon 603 showing an electronic mail function, an icon 604 showing a telephone function. The smartphone control process waits until any one function is selected and proceeds to step S802 after any one function is selected.

In step S802, the smartphone-side control circuit 210 determines whether or not the icon 602 showing an external camera function is selected based on the output of the operation section 261 in accordance with, for example, the user operation. Note that the display example shown in FIG. 12A shows a situation in which the icon 602 is highlighted and displayed after the icon 602 is selected. Here, the external camera function refers to a function of performing a coordinated operation which is controlled and operated by the smartphone 200 through communication with, for example, an image pickup function provided for an information device located outside the smartphone 200. The smartphone control process proceeds to step S804 when it is determined that the external camera function is selected or proceeds to step S803 when such a determination is not made. In step S803, the smartphone-side control circuit 210 executes a function provided for the smartphone 200 (other function) which is determined in step S802 as having been selected. After the process associated with the other function ends, the smartphone control process returns to step S801.

In step S804, the smartphone-side control circuit 210 determines whether or not the communication destination camera carrying out a coordinated operation through communication is already specified. When already set, the information associated with the communication destination camera is recorded, for example, in the recording circuit 150. The smartphone control process proceeds to step S806 when it is determined that the communication destination camera is already specified or proceeds to step S805 when such a determination is not made. In step S805, the smartphone-side control circuit 210 specifies the communication destination camera based on the output of the operation section 161 in accordance with, for example, the user operation and records the information associated with the specified communication destination camera, for example, in the recording circuit 150. After that, the smartphone control process proceeds to step S806.

Processes in step S806 and step S807 are similar to the processes in step S201 and step S202, respectively. That is, in step S806, the smartphone-side control circuit 210 causes the first communication section 181 to start a connection for communication with the specified communication destination camera. The description will be continued hereinafter assuming that the specified communication destination camera is the camera 100 according to the present embodiment. In step S807, the smartphone-side control circuit 210 determines whether or not the first communication, the connection of which is started in step S806, is established. The smartphone control process proceeds to step S810 when it is determined that the first communication is established or proceeds to step S808 when such a determination is not made.

In step S808, the smartphone-side control circuit 210 performs a process associated with sending notification to the user that the system is waiting for communication and giving a warning when a predetermined time period elapses. Note that notification of waiting until the first communication is established may be performed by voice or a display on the display section 162. The process in the present step is similar to the process in step S203. In step S809, the smartphone-side control circuit 210 determines whether or not to return to the display of a smartphone function list. The smartphone control process returns to step S801 when it is determined that the process is returned to the display of the smartphone function list or returns to step S804 when such a determination is not made and continues trial to establish communication.

In step S810 to step S812, the smartphone-side control circuit 210 performs processes similar to the processes in step S204 to step S206. That is, the smartphone-side control circuit 210 performs power ON communication with the camera 100 in step S810, performs thumbnail request communication with the camera 100 in step S811 and causes the display section 262 to display thumbnail images acquired through communication in step S812. Here, the function of the reproduction mode which is a sub function is selected instead of executing such control (function of the photographing mode) as to acquire images for photographing which is a main function, thus managing to avoid problems related to privacy or copyrights due to unintended acquisition of information. Note that power ON communication, thumbnail request communication and communication associated with thumbnail acquisition are carried out, for example, through first communication. Needless to say, the communications may be performed through second communication, but a case has been described here as an example where the communications are performed through first communication with low power consumption by effectively taking advantage of the fact that the thumbnail images have a small amount of information. The first communication has higher authentication speed than the second communication. Therefore, if the thumbnail images are acquired, for example, through the first communication, the user can easily view the thumbnail images. However, when a security level in communication is increased, the thumbnail images may be acquired and displayed using the second communication. Here, the thumbnail images according to the present embodiment correspond to the information list according to the first embodiment and the first modification. An example of a thumbnail display according to the present embodiment is shown in FIG. 12B as a schematic diagram. As shown in FIG. 12B, a thumbnail image group 610 showing various types of reproduction information including a first thumbnail image 611 and a second thumbnail image 612 is displayed on the display section 162 and presented to the user. Note that when thumbnails are displayed, a return icon 630 may also be provided to return to the state shown in FIG. 12A.

In step S813, the smartphone-side control circuit 210 determines whether or not the second communication with the camera 100 is established. The smartphone control process proceeds to step S816 when it is determined that the second communication is established or proceeds to step S814 when such a determination is not made. In step S814, the smartphone-side control circuit 210 performs a process on the second communication similar to the process in step S808. In step S815, the smartphone-side control circuit 210 stops the trial to establish the second communication and determines whether or not to end the coordinated operation. The smartphone control process proceeds to step S826 when it is determined that the coordinated operation is ended or returns to step S813 when it is determined that the coordinated operation is not ended and continues trial to establish the second communication. Note that the second communication may be established, for example, prior to communication to acquire thumbnails.

The process in step S816 is similar to the process in step S207, and processes in step S817 and step S818 are similar to the process in step S208, respectively. That is, in step S816, the smartphone-side control circuit 210 determines whether or not a reproduction image is selected. Here, the reproduction image according to the present embodiment corresponds to the presentation information according to the first embodiment and the first modification. The smartphone control process proceeds to step S817 when it is deteiinined in step S816 that the reproduction image is selected or proceeds to step S819 when such a determination is not made. An example of the reproduction image display when, for example, the reproduction image indicated by the first thumbnail image 611 is selected is shown in FIG. 12C as a schematic diagram. As shown in FIG. 12C, a reproduction image 640 is subjected to image processing so as to have a size and image quality suitable for reproduction and then displayed on the display section 262. In step S817, the smartphone-side control circuit 210 causes a selected reproduction image to be outputted to and reproduced on, for example, the display section 262. In step S818, the smartphone-side control circuit 210 determines whether or not to return to the thumbnail display and the selection of the reproduction image. In the present determination, when, for example, the user selects the return icon 650, it is determined that the process returns to the thumbnail display and the selection of the reproduction image. The smartphone control process returns to step S811 when it is determined that the process returns to the thumbnail display and the selection of the reproduction image or repeats the processes in step S817 and step S818 when such a determination is not made.

Note that notification that a partial invalidation of the functions of the display section 162 and the operation section 161 is executed, a warning that a partial invalidation of the function of the displacement section 140 is executed or the like may also be given, for example, in step S812.

Note that reproduction images or the like are acquired through the second communication. The acquisition of the thumbnail images which is described as an operation to be performed in S812 may be performed through the second communication in the present step.

In step S819, the smartphone-side control circuit 210 determines whether or not to transition to the photographing mode. The process in the present step is similar to the process in step S209. Note that the photographing mode according to the present embodiment corresponds to the recording mode according to the first embodiment. In the present determination, when the user selects the photographing icon 620 indicating transition to the photographing operation while thumbnails are displayed as shown, for example, in FIG. 12B, it is determined that transition is made to the photographing mode. Processes in step S820 to step S824 are similar to the process in step S210. That is, the smartphone-side control circuit 210 causes the camera 100 to start to acquire a live view image in step S820 and causes the display section 262 to display the live view image acquired from the camera 100 through communication. Note that images for a live view display are acquired through the second communication. The images for a live view display according to the present embodiment correspond to live information according to the first embodiment and the first modification.

An example of display on the display section 262 when the live view display according to the present embodiment is executed is shown in FIG. 12D. As shown in FIG. 12D, the display section 262 displays a live view display 660, an icon 670 indicating execution of communication for adjustment, an icon 680 indicating execution of communication for photographing control and an icon 690 indicating a process of returning to the thumbnail display.

The smartphone-side control circuit 210 causes the first communication section 281 to perform communication for adjustment including an adjustment instruction in step S821 according to the output of the operation section 261 in accordance with, for example, the user operation and determines in step S822 whether or not to cause the camera 100 to perform photographing. When it is determined that the camera 100 is caused to perform photographing, the smartphone control process causes the first communication section 281 to perform communication for recording control including a recording instruction in step S823, and then proceeds to step S824 or proceeds to step S824 when such a determination is not made. In step S824, the smartphone-side control circuit 210 determines whether or not to return to the thumbnail display and the selection of the reproduction image. The smartphone control process returns to step S811 when it is determined that the process returns to the thumbnail display and the selection of the reproduction image, or returns to step S820 when such a determination is not made and repeats the processes in step S820 to step S824 until it is determined in step S824 that the process returns to the thumbnail display and the selection of the reproduction image.

Note that when the function associated with photographing is partially invalidated, the smartphone-side control circuit 210 according to the present embodiment gives a warning to the user when the live view is displayed as shown, for example, in FIG. 12D.

In step S825, the smartphone-side control circuit 210 determines whether or not to end the coordinated operation. The smartphone control process proceeds to step S826 when it is determined that the coordinated operation is ended or returns to step S811 when such a determination is not made. In step S826, the smartphone-side control circuit 210 causes the first communication section 281 to perform power OFF communication with the camera 100. The process in the present step is similar to the process in step S212. After that, the smartphone control process returns to step S801.

### <Advantages of Information Recording System>

The information recording system 1 according to the present embodiment has the following advantages in addition to the advantages obtained in the first embodiment.

When communication with the smartphone 200 is established, the camera 100 according to the present embodiment determines whether or not to partially invalidate the functions of the display section 162 and the operation section 161, and the function of the displacement section 140 based on the state information acquired by the state acquisition section 115. In the determination, when, for example, it is determined that the camera 100 is in the bag, it is determined that the functions are partially invalidated. When it is determined that the functions are partially invalidated, the camera 100 limits the function of the reproduction mode through the partial invalidation. The function of the reproduction mode is a function that allows a recorded image to be displayed and expresses that acquisition of information such as photographing is not performed in the reproduction mode. Therefore, in a situation in which the user can check the state of the camera 100 and operate the camera 100, the user can perform a coordinated operation by operating either the camera 100 or the smartphone 200. On the other hand, in a situation in which the user cannot check the state of the camera 100 during a coordinated operation such as when the smartphone 200 is in the bag, partial invalidation is executed, and so the user can use the camera 100 from outside without worries about misoperation, unnecessary battery consumption, malfunction due to operation of the displacement section 140 in the bag or the like.

The camera 100 according to the present embodiment acquires brightness information of an image picked up by the image pickup section 130 and determines that the camera is in the bag when the brightness is less than a predetermined threshold. As the predetermined threshold, a value set in advance may be used or a brightness value acquired by the smartphone 200 may be used. In this way, the camera 100 according to the present embodiment determines an environment in which the camera 100 is disposed, for example, determining whether or not the camera is in the bag, and the user can thereby use the camera 100 without requiring time and effort to check the state of the camera 100.

When the brightness of an image picked up by the image pickup section 130 is less than a predetermined threshold, the camera 100 according to the present embodiment may acquire brightness information again while radiating auxiliary light and determine that the camera 100 is in the bag when the brightness acquired again is equal to or higher than the specific threshold. Such a configuration also allows the user to use the camera 100 without requiring time and effort to check the state of the camera 100.

When it is determined that the camera 100 according to the present embodiment is in the bag, the camera 100 prohibits operation including part of the function of the displacement section 140, execution of which may cause a malfunction of the camera 100. At this time, the camera 100 transmits to the smartphone 200, a control signal for warning the user that the operation is prohibited or a control signal for preventing the smartphone 200 from instructing execution of the operation concerned. Therefore, the user need not worry about mistakenly causing a malfunction of the camera 100 and can use a coordinated operation while comprehending that the camera 100 is in an inoperable state.

Note that although the displacement section 140 according to the present embodiment has been described as a lens or the like, the displacement section 140 is not limited to the case. The camera 100 according to the present embodiment may be provided with a dedicated element configured to be displaceable or deformable to acquire state information as the displacement section 140. Furthermore, the displacement section 140 may be provided with, for example, a distortion sensor, a temperature sensor or a luminance sensor.

### Modification of Second Embodiment

A modification of the second embodiment of the present invention will be described. Here, differences from the second embodiment will be described and identical parts are assigned identical reference numerals and description of the parts will be omitted.

The camera 100 configured to acquire brightness of an image as state information and determine whether or not the camera 100 is in the bag based on the state information has been described in the second embodiment. On the other hand, the camera 100 configured to acquire stress at the time of displacement acquired by the displacement section 140 provided for the camera 100 as state information will be described in the present modification.

The displacement section 140 according to the present modification is configured to be movable under the control of the camera-side control circuit 110. Furthermore, the displacement section 140 is further configured to be able to detect a load at the time of displacement. Furthermore, the presence or absence and the magnitude of the detected load at the time of displacement are outputted to the state acquisition section 115 as the presence or absence and the magnitude of stress at the time of displacement.

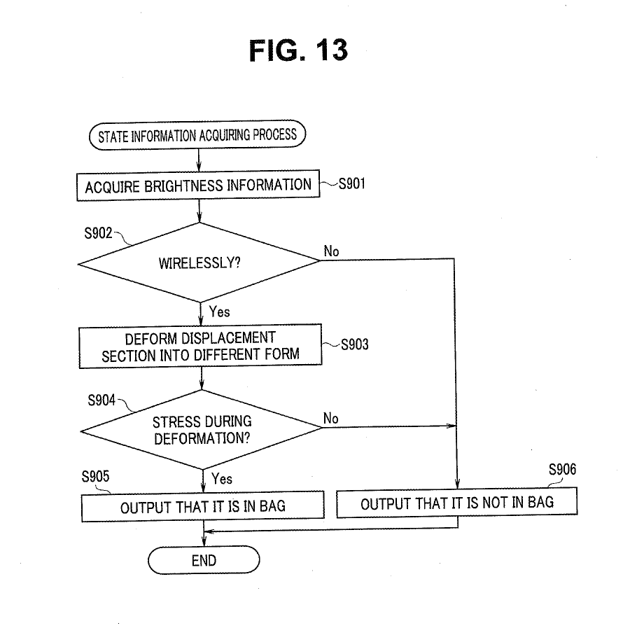

Here, another example of the state information acquiring process carried out in step S409 of the camera control process is shown in FIG. 13 as a flowchart and operation of the information recording system 1 will be described with reference to the flowchart.

In step S901, the camera-side control circuit 110 determines from which are of the operation section 161 and the first communication section 181 provided for the camera 100, the operation result acquired so far is acquired. In step S902, the camera-side control circuit 110 determines whether or not a coordinated operation is executed in which the camera 100 is operated through communication such as wireless communication. The state information acquiring process proceeds to step S903 when it is determined that the coordinated operation is executed through wireless communication or proceeds to step S906 when such a determination is not made.

In step S903, the camera-side control circuit 110 causes the displacement section 140 to deform into a plurality of different patterns. Note that the deformation patterns of the displacement section 140 are set in advance and recorded in the recording circuit 150 or the like. In step S904, the camera-side control circuit 110 determines whether or not a load (stress at the time of displacement) having a magnitude equal to greater than a predetermined threshold is detected when the displacement section 140 is deformed. The state information acquiring process proceeds to step S905 when it is determined that stress is detected at the time of displacement or proceeds to step S906 when such a determination is not made.

In step S905, the camera-side control circuit 110 outputs state information indicating that the camera 100 is in the bag to the state acquisition section 115. After that, the state information acquiring process ends. In step S906, the camera-side control circuit 110 outputs the state information indicating that the camera 100 is not in the bag to the state acquisition section 115. After that, the state information acquiring process ends.

In this way, the camera 100 according to the present modification determines that the camera 100 is in the bag when the magnitude of a load (stress at the time of displacement) imposed on the displacement section 140 during operation of the displacement section 140 is equal to or higher than a predetermined threshold. Advantages similar to the advantages of the second embodiment are achieved in the case too.

### <Modification>

The information recording system 1 may include artificial intelligence (AI) configured to record and learn determination results of the state information acquiring process, a situation in which the functions are partially invalidated, a way of using the information recording system 1 including the frequency of use by the user or the like, settings of the camera 100 or the like, and present various conditions set by the user, parameters or the like to the user. The AI may be constructed, for example, in a DSP and incorporated in the information recording system 1 or may be constructed on the Internet and located outside the information recording system 1. It goes without saying that the information recording system 1 including such an AI can perform a coordinated operation more suitable for a situation by causing the AI to learn past using situations of the camera 100 and function restricting situations.

The present technique is also effective for an image pickup apparatus that can be used in a situation in which the user has no image pickup section at hand such as a monitoring camera or an endoscope. By applying the present technique, the user can access the monitoring camera and check the recording video of the monitoring camera by operating the information terminal without causing unnecessary operation such as recording. Furthermore, by applying the present technique, it is possible to present a function operable at the time point according to the position of the endoscope camera and also implement an endoscope system that does not accept prohibited operation. Similarly, the present technique is also applicable to scientific or industrial devices such as microscopes. For example, the present technique is widely applicable to information acquisition devices, in a situation in which available information is not appropriate when used remotely or at timing at which acquisition of information is not appropriate. In this case, the user can access the endoscope camera or the like by operating an information terminal and check picked-up images of the endoscope camera or the like without causing misoperation.

Note that a case has been mainly described so far where a content (acquired information) recorded in an information acquisition device is checked, but the present invention is not limited to the case. For example, the information reproduced in the information acquisition device need not always be acquired and recorded by a device in which the function of the reproduction mode is executed.

Note that the present invention is not limited to the above-described embodiments, but can be modified in various ways without departing from the spirit and scope of the invention at an implementation phase. Moreover, the respective embodiments may be implemented in combination as appropriate, and effects of such a combination can be obtained in the case. Furthermore, the above-described embodiments include various inventions and various inventions can be extracted with a combination selected from a plurality of disclosed components. For example, even when several components are deleted from all the components presented in the embodiments, if problems can be solved and effects can be obtained, the configuration without such components can be extracted as an invention.

For example, a configuration of an information recording apparatus can also obtain effects similar to the effects of the aforementioned information recording apparatus 10 or the camera 100, and can be extracted as an invention, which includes functions of an information acquiring mode configured to acquire information or an information acquiring mode configured to acquire and record information and a reproduction mode configured to make the recorded information reproducible and capable of acquiring operation information from an external device through communication and performing a coordinated operation operating based on the operation information, the information recording apparatus including a communication section configured to perform communication with the external device and a mode control section configured to select the reproduction mode as a mode executed when the information recording apparatus is started in the coordinated operation through the communication.

What is claimed is:

1. An information recording apparatus including functions of a recording mode configured to acquire and record information and a reproduction mode configured to make recorded information reproducible and capable of acquiring operation information from an external device through communication and performing a coordinated operation based on the operation information, the information recording apparatus comprising:
a communication section configured to perform communication with the external device; and
a mode control section configured to select the reproduction mode as a mode executed when the information recording apparatus is started in the coordinated operation through the communication.

2. The information recording apparatus according to claim 1, further comprising:
an information presentation section configured to present the information to a user;
an operation section configured to acquire a user operation; and
a function restriction section configured to start in the coordinated operation and partially invalidate functions of the information presentation section and the operation section in the reproduction mode.

3. The information recording apparatus according to claim 1, further comprising:
an information presentation section configured to present the information to a user;
an operation section configured to acquire a user operation;
a state acquisition section configured to acquire information associated with a state of the information recording apparatus as state information; and
a function restriction section configured to determine, when the information recording apparatus is started in the coordinated operation and in the reproduction mode, whether or not to partially invalidate functions of the information presentation section and the operation section based on the state information and partially invalidate the functions based on the determination result.

4. The information recording apparatus according to claim 1, further comprising:
an information acquisition section configured to acquire the information;
an operation section configured to acquire a user operation;
a state acquisition section configured to acquire information associated with a state of the information recording apparatus as state information; and
a function restriction section configured to determine, in the recording mode after the information recording apparatus is started in the coordinated operation, whether or not to partially invalidate functions of the information acquisition section and the operation section based on the state information and partially invalidate the functions based on the determination result.

5. The information recording apparatus according to claim 2, wherein
the function restriction section generates a control signal for causing the external device to perform at least part of the invalidated functions, and
the communication section transmits the control signal to the external device.

6. The information recording apparatus according to claim 2, wherein
the function restriction section comprises a power control section configured to control power supplied to respective sections provided for the information recording apparatus, and
the power control section partially invalidates the functions by controlling the supplied power.

7. The information recording apparatus according to claim 3, further comprising an image pickup section configured to pick up and acquire an image, wherein
the state acquisition section acquires brightness of an environment in which the information recording apparatus is disposed based on the image as the state information, and
in the determination, the function restriction section determines, when the brightness is less than a predetermined threshold, that the functions are partially invalidated.

8. The information recording apparatus according to claim 3, further comprising:
an image pickup section configured to pick up and acquire an image; and
an illumination section configured to radiate illumination light, wherein
the state acquisition section acquires brightness of an environment in which the information recording apparatus is disposed based on the image as the state information, and
when the brightness is less than a predetermined threshold, the illumination section radiates the illumination light,
the state acquisition section further acquires the brightness while the illumination light is radiated based on the image acquired while the illumination light is radiated as the state information, and
in the determination, the function restriction section determines, when the brightness while the illumination light is radiated is equal to or higher than a predetermined threshold, that the functions are partially invalidated.

9. The information recording apparatus according to claim 3, further comprising a displacement section, a position or a shape of which is configured to be changeable, wherein
the state acquisition section causes the displacement section to operate and acquires a magnitude of a load received when the displacement section operates as the state information, and
in the determination, the function restriction section determines, when the magnitude of the load is equal to or higher than a predetermined threshold, that the functions are partially invalidated.

10. The information recording apparatus according to claim 2, wherein
the function restriction section generates a control signal for invalidating a user operation in the external device associated with the invalidated functions, and
the communication section transmits the control signal to the external device.

11. The information recording apparatus according to claim 2, wherein
the function restriction section comprises a notification control section configured to generate a control signal for warning the user, using the external device, that the invalidation is executed, and
the communication section transmits a control signal associated with the warning to the external device.

12. An information recording system comprising:
the information recording apparatus according to claim 1; and
the external device.

13. A method for controlling an information recording apparatus including functions of a recording mode configured to acquire and record information and a reproduction mode configured to make recorded information reproducible and capable of acquiring operation information from an external device through communication and performing a coordinated operation operating based on the operation information, the method comprising:
performing communication with the external device; and
selecting the reproduction mode as a mode executed when the information recording apparatus is started in the coordinated operation through the communication.
